(19) United States
(12) Patent Application Publication
(10) Pub. No.: US 2015/0154721 A1
(43) Pub. Date: Jun. 4, 2015

(54) SYSTEM, APPARATUS AND METHOD FOR USER TO OBTAIN SERVICE FROM PROFESSIONAL

(71) Applicant: Melissa Thompson, New York, NY (US)

(72) Inventor: Melissa Thompson, New York, NY (US)

(73) Assignee: TALKSESSION, INC., New York, NY (US)

(21) Appl. No.: 14/557,538

(22) Filed: Dec. 2, 2014

Related U.S. Application Data
(60) Provisional application No. 61/910,775, filed on Dec. 2, 2013.

(51) Int. Cl. G06Q 50/22; G06F 19/00; G06Q 10/06

(52) U.S. Cl. CPC G06Q 50/22; G06Q 10/063112; G06F 19/34

(57) ABSTRACT

Computer-implemented tools (such as systems, apparatuses, methods, application software, computer program products, etc.) can be provided to match and connect consumers with wellness professionals. Such tools may employ an intelligent module that takes into account various information collected from or regarding the patient, such as physical, emotional, and/or verbal traits, and/or other behavioral patterns or personal profile information, as well as other contextually relevant information to perform the matching.

### CROSS-REFERENCE TO RELATED APPLICATION

This application claims the benefit of U.S. Provisional Application No. 61/910,775, filed Dec. 2, 2013 and entitled “SYSTEM, APPARATUS AND METHOD FOR USER TO OBTAIN SERVICE FROM PROFESSIONAL”.

### TECHNICAL FIELD

This disclosure relates to tools (such as systems, apparatuses, methodologies, computer program products, etc.) for a user to obtain services through a network, and more particularly, for a user or patient to obtain such service from wellness professionals matched to the user and/or patient (based on wellness data collected from the user, patient or otherwise).

### BACKGROUND

In the modern age, advancements in communication technology has allowed information to be easily accessible. Such information access has also become one of the regular driving factors for consumers to expect greater access to services, on demand.

Conventional modes of obtaining health and wellness services have often times been frustrating and inconvenient for consumers. For example, the typical healthcare consumer relies on information received by word-of-mouth to select a professional for obtaining health and wellness services. However, such information can be highly subjective and incomplete, and the consumer may need to apply a trial-and-error approach over several iterations until the consumer finds a suitable professional who matches the health, wellness and/or other needs of the consumer. Further, such services are typically obtained by appointment only, and such appointments may need to be made weeks (if not months) in advance. In addition, availability of qualified wellness professionals within reasonable geographical distance may sometimes be limited. The necessity of travel and planning makes such approach for obtaining the desired services unpopular and even frustrating. Consumers in our on-demand society are becoming increasingly dissatisfied with such by-appointment-only approach to obtaining health and wellness services or even with not being able to access the desired services at all.

On the other hand, the by-appointment approach is likewise, from the perspective of the service provider, not necessarily satisfactory, since no-shows and cancellations of appointments can lead the service provider to be undesirably idle. However, making availability of the service provider known to the public is not necessarily an easy task, particularly when such information is delivered by word-of-mouth. Further, service providers are not particularly motivated to abandon the by-appointment business approach, since a system that largely relies on walk-in patients can lead to some days of being too busy (i.e. not enough time to attend to all of the walk-in patients) and some days of too much idleness. In addition, a walk-in approach may require the service provider to incur a higher level of risk that services rendered will not be, or will be inadequately, compensated.

A system for consumers to remotely connect with wellness professionals to allow consumer needs for wellness services to be better met and allow the service providers to minimize the instances of being idle is needed.

### BRIEF SUMMARY

Various tools (for example, a system, an apparatus, application software, a methodology, etc.) can be configured to meet the consumer demand for the services of wellness professionals.

In an aspect of this disclosure, there is provided a system that enables a user to search and find relevant counseling from wellness professionals at the convenience of the user, from a mobile device or another network-connected terminal. For example, the system may automatically match a patient to wellness professionals or service providers that match specific needs and/or attributes of the patient, to qualifications of the professional. Such system can be configured to enable on-demand client request of an immediate session with a user specified professional, or a professional selected based on recommendations of available and appropriate professionals, to obtain on-demand assistance from wellness professionals extending nationally or perhaps even internationally. The system based on availability may allow the user to find a counselor at any time of day, to obtain a one-to-one interactive session with a professional having relevant expertise. Thus, service consumers can be enabled to improve their well-being through simplified access to highly personalized professional advice and content under circumstances or at times that fit their lifestyles.

The user of the tool can be the patient or a wellness provider seeking to match the patient to a specialist and/or another wellness professional to share in collaborative care on behalf of the patient. That is, the tools can be employed to attain real-time, live, collaborative care between providers and/or between patient and providers, to improve quality of care, speed of care, efficacy of the system, costs, etc.

The tools can employ any one or more of various technologies (for example, video technology, auditory technology, sensory technology, artificial intelligence techniques, etc.) to detect a person's physical, emotional, and/or verbal traits, and/or other behavioral patterns or personal profile information, to make one or more recommendations with respect to a wellness professional, or otherwise. For example, the tools may be configured to calculate a wellness index of the patient, with the goal of matching the patient with a highly relevant wellness provider.

Such tools can be applied in any of various settings, such as correctional setting, school setting, hospital setting (where on-site specialist is not available), ACO (accountable care organization) setting, mobile care setting, etc.

The aforementioned features may be provided via a platform, application or other software, as a service through a network.

In another aspect, the system can be configured to enable the professional to deliver therapeutic services to consumers through secure video or chat sessions through a web-browser or mobile device application, and through written and web-broadcasted content. The system may be configured to include a SaaS (software as a service) platform or PaaS (platform as a service) that enables healthcare or wellness professionals to conduct and grow their practices, within a secure and user-friendly network of wellness advisors. Such platform allows professionals to participate selectively (e.g., in order to maintain a full schedule) by indicating availability in real-time, and when selected by the service consumer, deliver live, secure counseling sessions over a network, such as via streaming video or chat session, with the service consumer via a Web browser or an application on a mobile, desktop or other device.

The system un-tethers both professional and client from any specific location for a “session” (that is, both or neither can be mobile and sessions can be recorded for archival or future playback), while injecting more efficiency according to supply/demand in the network of professionals.

In another aspect, the system may additionally or optionally include provisions for (i) ranking and reviews of a professional by a service consumer, after each session, and making such ranking information or reviews (anonymously) to other users, (ii) inviting a friend or family member to participate in a live session, and (iii) recommending a professional to others.

The system may additionally or optionally include other features to assist the professionals to optimize and grow their practices, such as, for example, provisions via cloud computing (e.g., without specific native software on the professional side) for (a) developing content-rich profiles, (b) accessing automated analytics tools, (c) submitting claims to insurers for services performed, (d) educational materials, and (e) assistance in personal branding.

In another aspect, the automated matching of service consumer and professional can include insurance reimbursement requirements of the professional, so that risk of uncompensated services can be selected by the professional. A professional who opts to minimize such risks would of course have fewer matches than otherwise. On the other hand, the system can be configured to match service consumers who do not have insurance coverage with wellness professional who do not specify insurance reimbursement requirements.

### BRIEF DESCRIPTION OF THE DRAWINGS

The aforementioned and other aspects, features and advantages can be more readily understood from the following detailed description with reference to the accompanying drawings wherein:

FIG. 1A is a block diagram schematically showing a system for a user to obtain professional services from professionals, according to an exemplary embodiment;

FIG. 1B is a block diagram schematically showing a system for a user to obtain professional services from professionals, according to another exemplary embodiment;

FIG. 1C is a block diagram schematically showing a system for a user to obtain professional services from professionals, according to another exemplary embodiment;

FIG. 2 is a block diagram schematically showing an exemplary configuration of a terminal;

FIG. 3 is a block diagram schematically showing an exemplary configuration of a computing device;

FIG. 4 shows an example of data that can be stored in an accounting database;

FIG. 5 shows an example of data that can be stored corresponding to health and wellness professionals;

FIG. 6A is a flow chart showing a method that can be performed by the referral application or service, according to the exemplary embodiments shown in FIGS. 1A-1C;

FIG. 6B is a flow chart showing another method that can be performed by the referral application or service, according to the exemplary embodiments shown in FIGS. 1A-1C;

FIGS. 7A-7H show examples of user interface display screens that can be displayed on a patient terminal, according to the exemplary embodiments shown in FIGS. 1A-1C;

FIG. 8A is a flow chart showing a method that can be performed by the referral application or service, according to the exemplary embodiments shown in FIGS. 1A-1C;

FIG. 8B is a flow chart showing another method that can be performed by the referral application or service, according to the exemplary embodiments shown in FIGS. 1A-1C;

FIGS. 9A-9F show examples of user interface display screens that can be displayed on a patient terminal, according to the exemplary embodiments shown in FIGS. 1A-1C;

FIG. 10 is a flow chart showing a method that can be performed by the referral application or service, according to the exemplary embodiments shown in FIGS. 1A-1C;

FIGS. 11A-11D show examples of user interface display screens that can be displayed on a patient terminal, according to the exemplary embodiments shown in FIGS. 1A-1C;

FIGS. 12A-12E show examples of user interface display screens that can be displayed on a professional terminal, according to the exemplary embodiments shown in FIGS. 1A-1C;

FIG. 13 is a block diagram showing an intelligent matching module that can be integrated in the patient-to-professional matching apparatus 103 and/or referral application or service, in the exemplary embodiments shown in FIGS. 1A-1C; and

FIG. 14 shows a tabular summary of a wellness index calculation, in one example, in a university setting.

### DETAILED DESCRIPTION

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. In addition, a detailed description of known functions and configurations is omitted when it may obscure inventive aspects of the present disclosure. Referring now to the drawings, wherein like reference numerals designate identical or corresponding parts throughout the several views, there are described tools (e.g., systems, apparatuses, methodologies, computer program products, etc.) for enabling a user to obtain wellness services from wellness professionals matched to the user or a patient.

As discussed more in detail and should be understood from such discussion, the terms “user” and “patient” as used herein can be, but is not always, synonymous. In some contexts, the user would be someone (such as a primary physician, a social worker, etc.) seeking a referral on behalf of the patient. In some other contexts, the user is the wellness professional or someone operating in place of the wellness professional on the wellness service provider's side.

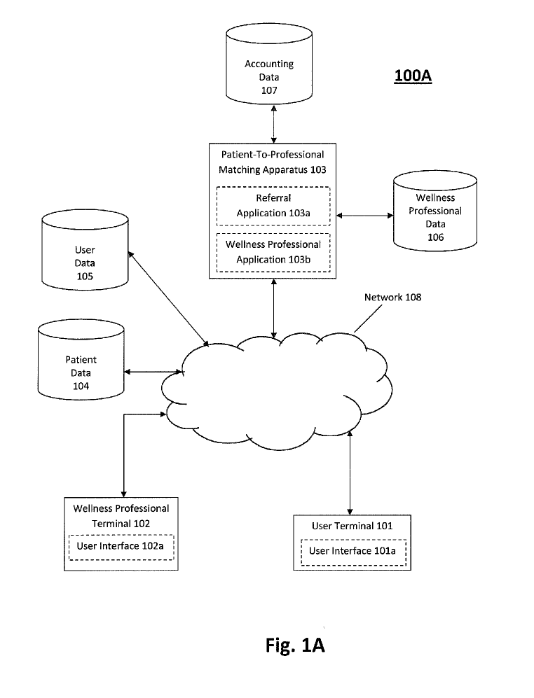

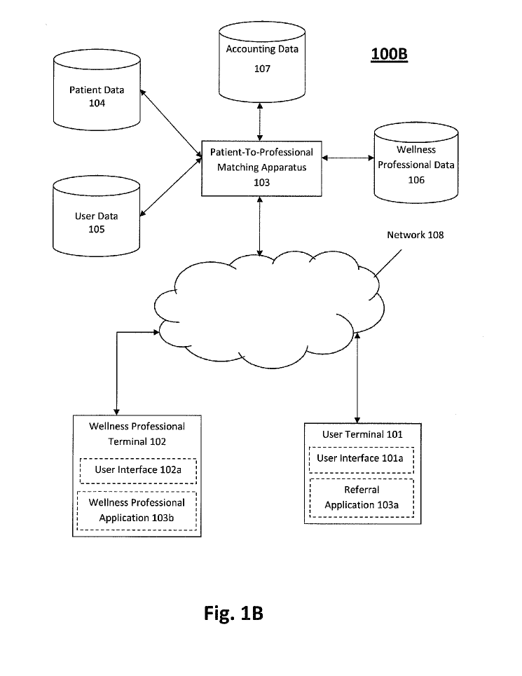

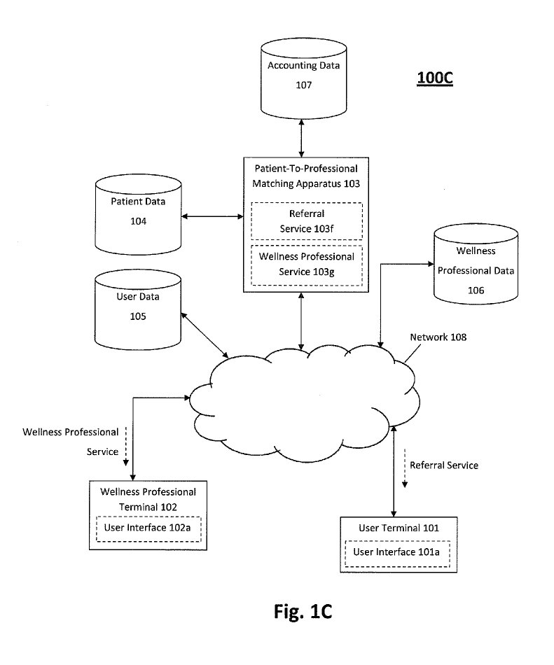

FIG. 1A shows schematically a system 100A that includes a user terminal 101, a wellness professional terminal 102 and a patient-to-professional matching apparatus (e.g., an application server) 103, a patient database 104 and a user database 105, all of which are interconnected by network 108.

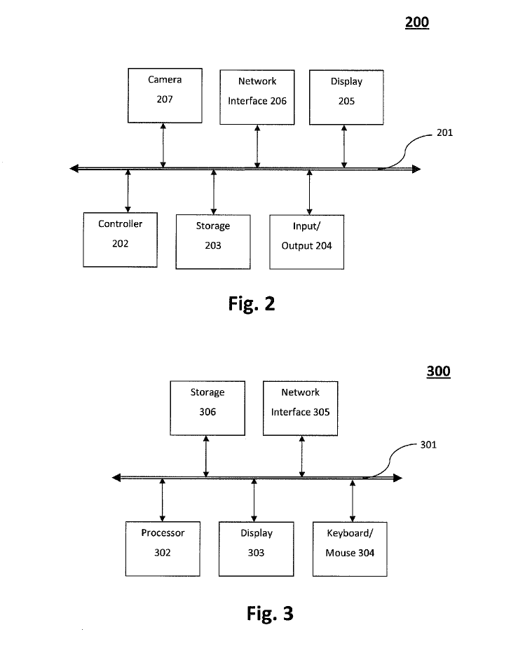

The user terminal 101 and the wellness professional terminal 102 can be any information terminal, including but not limited to a notebook computer, a tablet computer, a mobile phone or handset, a PDA (personal digital assistant), another computing device, etc., that can, and is configured to, communicate with other devices through the network 108. The user terminal 101 and the physician terminal 102 may be configured as shown in FIG. 2, which is discussed infra.

The user terminal 101 includes user interface 101a which allows a user to access various content and software applications. For example, the user interface 101a provides means for the user to access various mobile applications (commonly known as “apps”), a browser application through which the user can access the web, etc. The user may operate the user interface 101a on the user terminal 101 to access a referral application 103a from the patient-to-professional matching apparatus 103. The user, who may be suffering from a disorder or may be currently experiencing other wellness issues, can use the referral application 103a to search for wellness professionals who have the knowledge and experience to provide a proper treatment or diagnosis.

In addition, the user interface may include a graphical user interface through which the user can input protected (or personal) health information (PHI) and/or other personal information for registering an account on the referral application 103a, such as name, age, gender, contact information (e.g., e-mail address, residential address, phone number, etc.), insurance information, preferred contacting method (e.g., texting, video chat, voice-only chat), preferred language of communication (e.g., English, French, Russian, sign language, etc.), wellness issues that the user previously experienced and/or is currently experiencing, whether the user has been in therapy before, their favorite magazines, words they would describe themselves as, words other people would describe themselves as, etc. The user interface 101a may also be integrated with a microphone, through which the user can answer preliminary questions pertaining to the user and/or patient, and the referral application 103a may be configured to record the responses of the user. Likewise the user may also use the microphone when communicating with a wellness professional via video-chat.

Further, the user interface may include, or may be integrated with, components for speech processing, voice recognition, fingerprint scanning, facial recognition, retina scanning, other forms of biometric data collection, etc. Such components, like the user interface 101a, can include a combination of software and hardware components, and can be configured for various purposes, including collection of wellness data, facilitate secure login to the referral application 103a, etc. Since data collection provisions are generally known in the art, and do not form an inventive aspect of this disclosure, details thereof are not provided herein in order to avoid obscuring the inventive aspects of this disclosure.

The wellness professional terminal 102 includes user interface 102a which allows a wellness professional to access various content and software applications. For example, the user interface 102a provides means for the user to access various mobile applications (commonly known as “apps”), a browser application through which the user can access the web, etc. For example, the wellness professional may operate the user interface 102a on the wellness professional terminal 102 to access a wellness professional application 103b from the patient-to-professional matching apparatus 103.

In addition, the user interface 102a may include a graphical user interface through which the wellness professional can create a profile of himself or herself. Such information in the profile may include, but is not limited to, gender, qualifications (e.g., school, licensing, certification, years of experience, etc.), specialization, nationality, etc. Further, the wellness professional may use the user interface 102a to access various accounting information from the wellness professional application 103b.

The patient-to-professional matching apparatus 103 provides processing for the referral application 103a (used by the user) and the wellness professional application 103b (used by the wellness professional). In addition to providing the applications, the patient-to-professional matching apparatus 103 may also access, or provide access to, patient database 104 which stores wellness data obtained from the user (e.g., PHI, biometrics, etc.), wellness professional database 106 (e.g., storing wellness professional profiles) and accounting database 107 (e.g., bills, outstanding payments, time accounting information, etc.).

The referral application 103a is configured to register an account for a user and determine whether the user is authorized to utilize the services of the referral application 103a. In addition, the referral application collects information from the user (e.g., PHI, answers to preliminary questions, biometric data, criteria for wellness professionals, etc.). Further, the referral application 103a is configured to compile a list of wellness professionals who best match the user by searching within the wellness professional database 106. Then, the referral application 103a compiles a list from the search performed and sends it to the user. Once the user receives the list, he or she can select a wellness professional and the referral application 103a connects the user with the wellness professional. The referral application 103a also records the length of time of a session that the patient is with the wellness professional and after the patient is finished communicating with the wellness professional, stores the session time information, the rate of the wellness professional and the diagnosis by the wellness professional for the patient, in the accounting database 107.

The wellness professional application 103b is utilized by wellness professionals to perform various tasks. For example, the wellness professional application 103b may be used to create a profile for the wellness professional. Such information in the profile may include, but is not limited to, gender, qualifications (e.g., school, licensing, certification, years of experience, etc.), specialization, nationality, etc. In addition, the wellness professional application 103b may be used to keep track of patients the wellness professional has previously treated or is currently treating. Further, the wellness professional application 103b may also keep accounting information as well. For example, the wellness professional may be able to access payments by current patients or outstanding payments by former clients. However, another feature of the wellness professional application 103b is that it allows the wellness professional to set his or her availability and communicate with patients remotely.

The patient database 104 is a database which stores PHI (protected health information), including wellness data, and other patient data. For example, the PHI may include name, residential address, date, phone numbers, fax numbers, e-mail addresses, social security numbers medical record numbers health insurance beneficiary numbers, account numbers certificate/license numbers, vehicle identifiers, device identifiers, biometric identifiers (e.g., fingerprint, retinal, voice prints, etc.), photographic images, etc.

The user database 105 is a database which stores information regarding the user of the user terminal 101. The user terminal 101 may not only be used by patients but by others (e.g., physicians, nurses, social workers, secretaries, etc.) as well. The information stored in the user database 105 may include the username, password, PHI (e.g., name, contact information, title, role, etc.) of the user, etc.

The wellness professional database 106 is a database which stores information regarding wellness professionals. Such information may include the name, gender, location, specialty, rate, board certification status and education of the wellness professionals.

The accounting database 107 is a database which stores information regarding the transactions and outstanding payments between a wellness professional and a patient. For example, the accounting data can be costs accumulated from a patient-wellness professional session.

The network 108 can be a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 103. In addition, the network 103 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

FIG. 1B shows schematically a system 100B, according to another exemplary embodiment. The system 100B is similar to the system 100A except that the referral application 103a and the wellness professional application 103b are located on the user terminal 101 and the wellness professional terminal 102, respectively, and both the patient database 104 and the user database 105, in FIG. 1B, are connected to the patient-to-professional matching apparatus 103, instead of being connected to network 108.

In this case, the referral application 103a and the wellness professional application 103b are installed on the user terminal 101 and the wellness professional terminal 102, respectively, and the processing is largely performed natively. On the other hand, in the system 100A shown in FIG. 1A, processing is largely performed on the server side of the apparatus 103.

Otherwise, operations of the elements of the system 100B are similar to those discussed in connection with the corresponding elements of the system 100A of FIG. 1A.

FIG. 1C shows schematically a system 100C, according to another exemplary embodiment. The system 100C is similar to the system 100A of FIG. 1A except that (a) the system 100C additionally includes referral service 103f and wellness professional service 103g, (b) the wellness professional database 106 is connected to network 108 in FIG. 100C (and is not connected directly to the patient-to-professional matching apparatus 103), and (c) the patient database 104 is connected directly to the patient-to-professional matching apparatus 103.

The referral service 103f and the wellness professional service 103g provided by the patient-to-professional matching apparatus 103 shown in FIG. 1C are similar to the referral application 103a and the wellness professional application 103b. In system 100C, when a user of the user terminal 101 wishes to utilize the referral service 103f, the user terminal 101 can simply interact with the patient-to-professional matching apparatus 103 without having to install client software on the terminal (or even in a case that client software is installed, it is merely a thin client, such as in a form of essentially a user interface with the referral service 103f on the wellness professional application 103b). Likewise, the wellness professional using the wellness professional terminal 102 may also utilize the wellness professional service 103g without having to install client software on the wellness professional terminal 102. Thus, the referral service 103f and the wellness professional service 103g are provided to the patient terminal 103a and the wellness professional terminal 103b, respectively, on demand.

Otherwise, operations of the elements of the system 100C are similar to those discussed in connection with the corresponding elements of the system 100A of FIG. 1A.

While the components of each of the systems 100A-100B are shown in FIGS. 1A-1C, respectively, to be connected to the network 108, this may not always be the case. For example, the terminal 101 and terminal 102 may connect directly with any of the databases 104, 105, 106, 108 directly and not through the patient-to-professional matching apparatus 103, such as when the address (e.g., IP Address, Mac Address, URL, etc.) of the database is known, and in some instances, may connect directly to it in a peer-to-peer fashion. Likewise, the user terminal 101 may also directly connect with the wellness professional terminal 102, via any of various known applications (such as Facetime, Skype, etc.).

As discussed herein, and/or will otherwise be apparent from such discussion, each of the systems shown in FIGS. 1A-1C can be configured (via software and/or hardware components) to perform any one or more of the following:
a process of using a person's physical, emotional, and/or verbal traits, and/or other behavioral patterns or personal profile information, to make one or more recommendations, such as by applying artificial intelligence techniques, to the same person or another person or other persons;
a process of using any one or more of various technologies to detect a person's physical, emotional, and/or verbal traits, and/or other behavioral patterns or personal profile information, to make one or more recommendations, such as by applying artificial intelligence techniques, to the same person or another person or other persons;
a process of using video technology to detect a person's physical, emotional, and/or verbal traits, and/or other behavioral patterns or personal profile information, to make one or more recommendations, such as by applying artificial intelligence techniques, to the same person or another person or other persons;
a process of using auditory technology to detect a person's physical, emotional, and/or verbal traits, and/or other behavioral patterns or personal profile information, to make one or more recommendations, such as by applying artificial intelligence techniques, to the same person or another person or other persons;
a process of using sensory technology to detect a person's physical, emotional, and/or verbal traits, and/or other behavioral patterns or personal profile information, to make one or more recommendations, such as by applying artificial intelligence techniques, to the same person or another person or other persons;
a process of any one or more of various technologies to detect a person's physical, emotional, and/or verbal traits, and/or other behavioral patterns or personal profile information, to make one or more recommendations, such as by applying artificial intelligence techniques, to the same person or another person or other persons, such as a potential or a current patient, and the recommendation is a recommendation of a professional in the field of medicine;
a process of using video/auditory/sensory technology to detect a person's physical, emotional, and/or verbal traits, and/or other behavioral patterns or personal profile information, to make one or more recommendations, such as by applying artificial intelligence techniques, to another person or persons, such as a potential or a current patient, and the recommendation is a recommendation of a professional in the field of medicine;
a process of any one or more of various technologies to detect a person's physical, emotional, and/or verbal traits, and/or other behavioral patterns or personal profile information, to make one or more recommendations, such as by applying artificial intelligence techniques, to another person or persons, such as a potential or a current patient, and the recommendation is a recommendation of a professional in the field of mental and/or behavior health and wellness;
a process of using video/auditory/sensory technology to detect a person's physical, emotional, and/or verbal traits, and/or other behavioral patterns or personal profile information, to make one or more recommendations, such as by applying artificial intelligence techniques, such as a potential or a current patient, and the recommendation is a recommendation of a professional in the field of mental and/or behavior health and wellness;
a process of any one or more of various technologies to detect a person's physical, emotional, and/or verbal traits, and/or other behavioral patterns or personal profile information, to determine an underlying medical condition;
a process of any one or more of various technologies to detect a person's physical, emotional, and/or verbal traits, and/or other behavioral patterns or personal profile information, to determine the probability of an underlying psychological condition;
a process of any one or more of various technologies to detect a person's physical, emotional, and/or verbal traits, and/or other behavioral patterns or personal profile information, to determine the probability of an underlying psychiatric condition;
a process of any one or more of various technologies to detect a person's physical, emotional, and/or verbal traits, and/or other behavioral patterns or personal profile information, to determine the probability of one or more particular disorders (e.g., anxiety, depression, etc.); and
a process of any one or more of various technologies to detect a person's physical, emotional, and/or verbal traits, and/or other behavioral patterns or personal profile information, to determine the probability of one or more particular disorders, and informing a relevant provider match based on that probability.

The term “wellness data”, as should be understood from its use herein, can denote any and all of the data that may be used by the patient-to-professional matching apparatus and/or referral application or service to characterize the patient, personally or otherwise, through attributes for matching the patient to one or more wellness professionals. Such wellness data may include physical, emotional, and/or verbal traits, behavioral patterns, other biometric attributes, personal profile information, social attributes, environmental attributes, etc.

An example of a configuration of a terminal that may be employed for the user terminal 101 and the wellness professional terminal 102 is shown schematically in FIG. 2. In FIG. 2, a terminal device 200 includes a controller (or central processing unit) 202 that communicates with a number of other components, including storage 203, other input/output (such as mouse, touchpad, stylus, keyboard/keypad, microphone and/or speaker with voice/speech interface and/or recognition software, motion sensing device, nerve signal sensing device, image recognition device, etc.) 204, display 205, network interface 206 and a camera 207, by way of an internal bus 201.

The storage 203 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 206 provides a connection (for example, by way of an Ethernet connection or other network connection which supports any desired network protocol such as, but not limited to TCP/IP, IPX, IPX/SPX, or NetBEUI) to a network (e.g. network 108 shown in FIGS. 1A-1C). The network interface is configured to communicate with any particular device amongst plural heterogeneous devices that may be included in a system in a communication format native to the particular device. The network interface may determine an appropriate communication format native to the particular device by any of various known approaches. For example, the network interface may refer to a database or table, maintained internally or by an outside source, to determine an appropriate communication format native to the device. As another example, the network interface may access an Application Program Interface (API) of the particular device, in order to determine an appropriate communication format native to the device.

The camera 207 is, for example, a digital camera including a series of lenses, an image sensor for converting an optical image into an electrical signal, an image processor for processing the electrical signal into a color-corrected image in a standard image file format, and a storage medium for storing the processed images. The series of lenses focus light onto the sensor [e.g. a semiconductor device such as a charge-coupled device (CCD) image sensor or a complementary metal-oxide-semiconductor (CMOS) active pixel sensor] to generate an electrical signal corresponding to an image of a scene. The image processor then breaks down the electronic information into digital data, creating an image in a digital format. The created image is stored in the storage medium (e.g. a hard disk or a portable memory card). The camera 207 may also include a variety of other functionalities such as optical or digital zooming, auto-focusing and HDR (High Dynamic Range) imaging.

Additional aspects or components of the terminal device 700 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

FIG. 3 shows an exemplary constitution of a computer 300 that can be configured (for example, through software) to operate (at least in part) as the patient-to-professional matching apparatus 103 of FIG. 1A. As shown in FIG. 3, the management unit 300 includes a controller (or central processing unit) 302 that communicates with a number of other components, including display 303, keyboard/mouse 304, network interface 305 and memory or storage part 306, by way of a system bus 301. The computing device 300 may be a special-purpose device (such as including one or more application specific integrated circuits or an appropriate network of conventional component circuits) or it may be software-configured on a conventional personal computer or computer workstation with sufficient memory, processing and communication capabilities to operate as a terminal and/or server, as may be appreciated to those skilled in the relevant arts.

Additional aspects or components of the computing device 300 are conventional (unless otherwise discussed herein), and in the interest of clarity and brevity are not discussed in detail herein. Such aspects and components are discussed, for example, in “How Computers Work”, by Ron White (Que Corporation 1999), and “How Networks Work”, by Frank J. Derfler, Jr. and Les Freed (Que Corporation 2000), the entire contents of each of which are incorporated herein by reference.

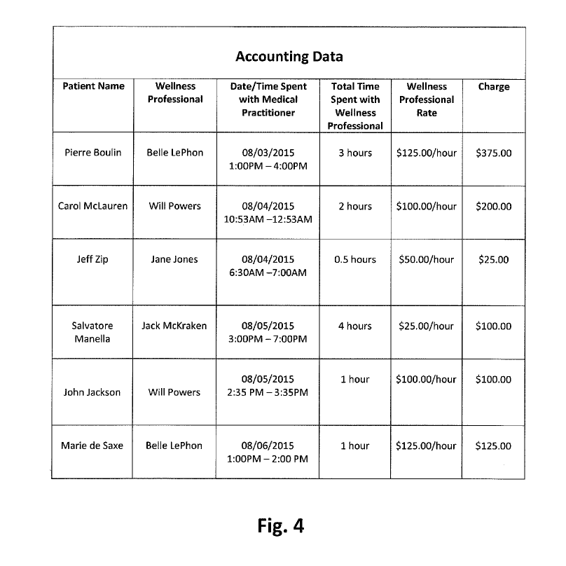

FIG. 4 shows an example (in the form of a table) of accounting data that is stored in the accounting database 107. As shown in FIG. 4, the table includes information regarding the sessions between a patient and a wellness professional and the costs resulting from the total time of the session. This is vital to the wellness professional as it allows him or her to not only keeps track of the payments and bills from the patients but to also provide evidence that the session had taken place.

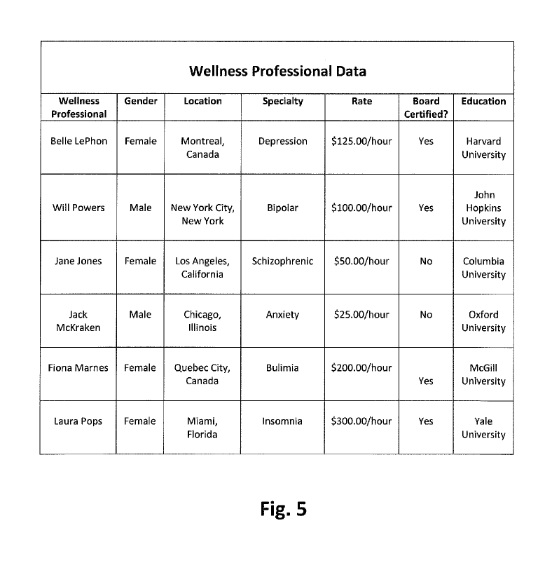

FIG. 5 shows an example of wellness professional data that is stored in the wellness professional database 106. As shown in FIG. 5, the table includes information regarding each wellness professional such as name, gender, location, specialty, rate, board certification status and education.

When a user uses the referral application 103a to search for wellness professionals, the referral application 103a searches the data stored in the wellness professional database 106. The criteria input by the user as well as any information previously gathered for or regarding the patient is used to parse through the information regarding the wellness professionals, for the best fit.

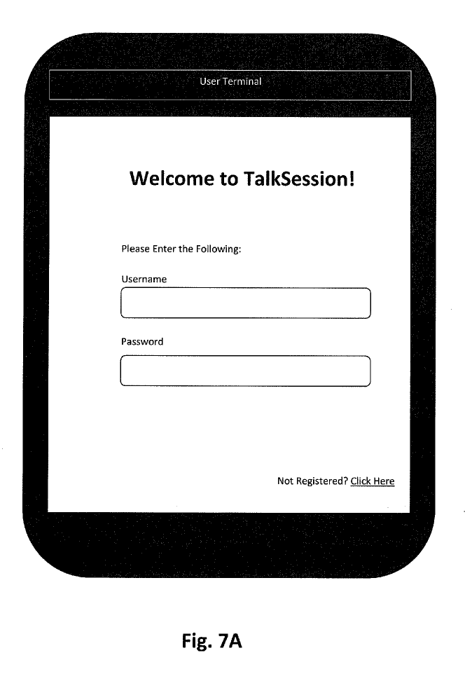

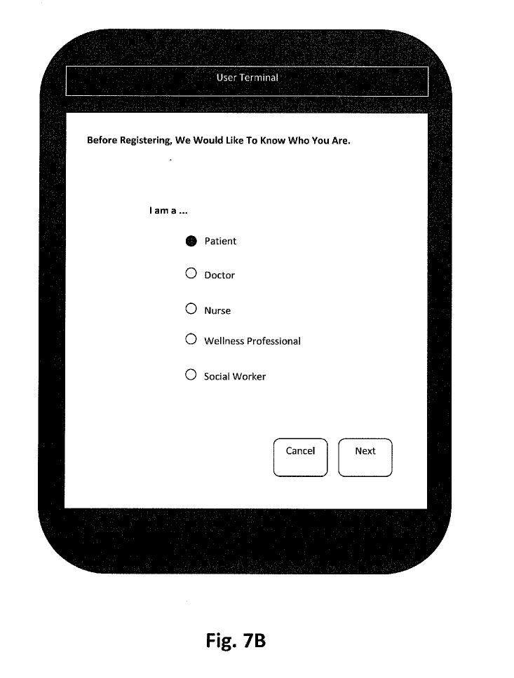

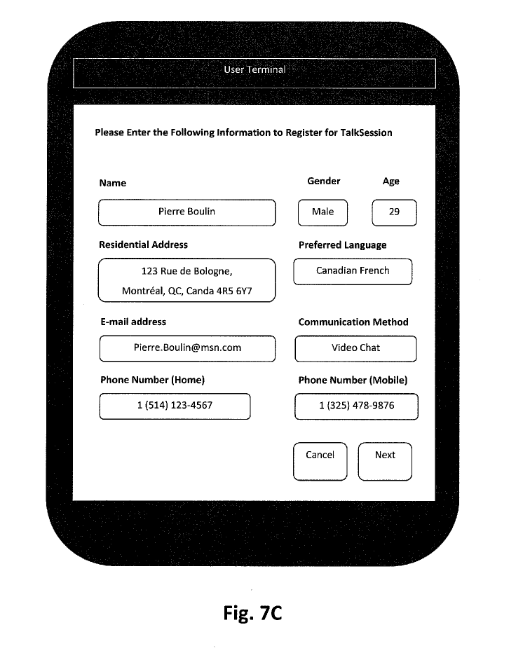

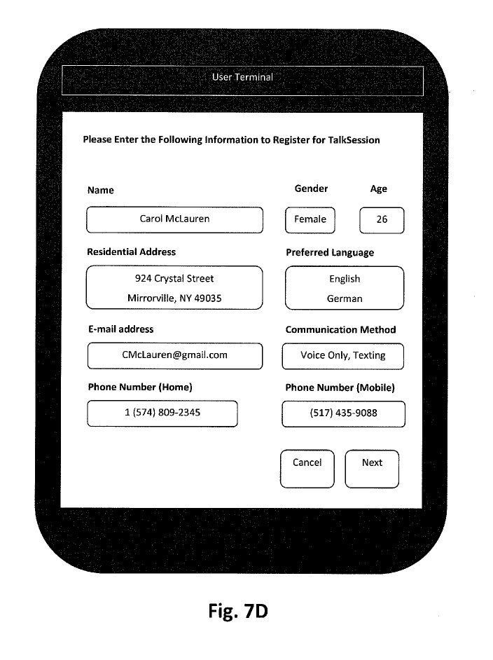

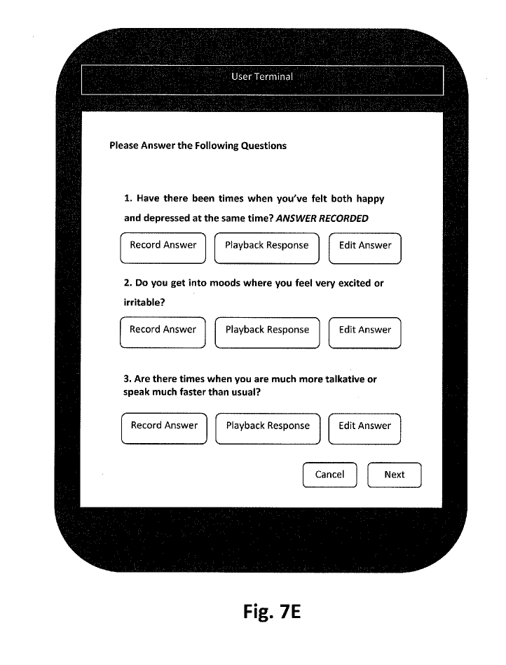

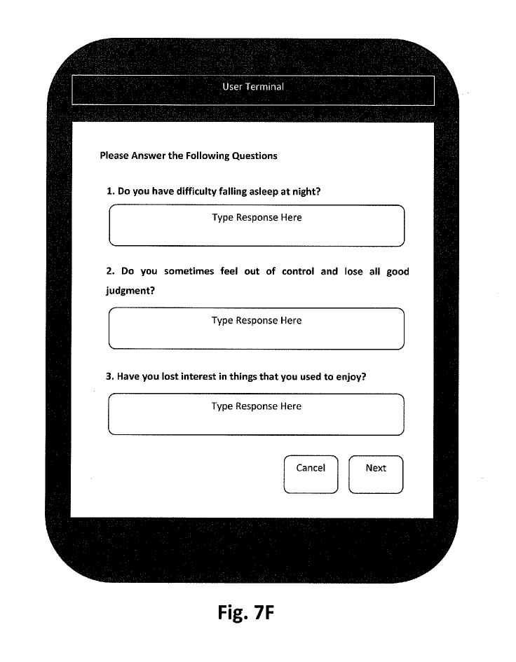

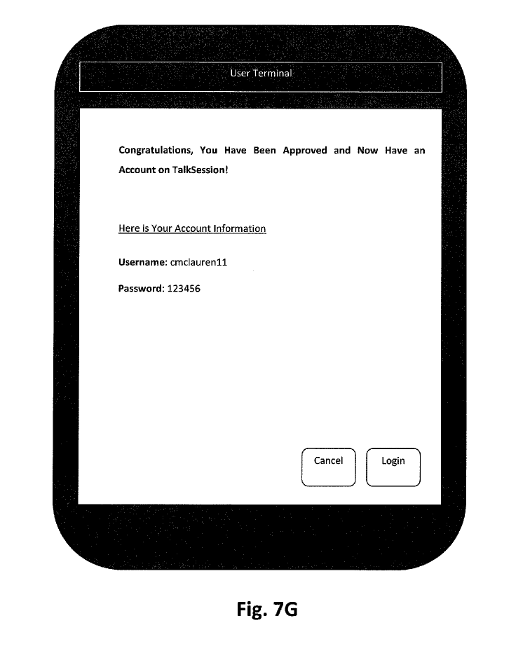

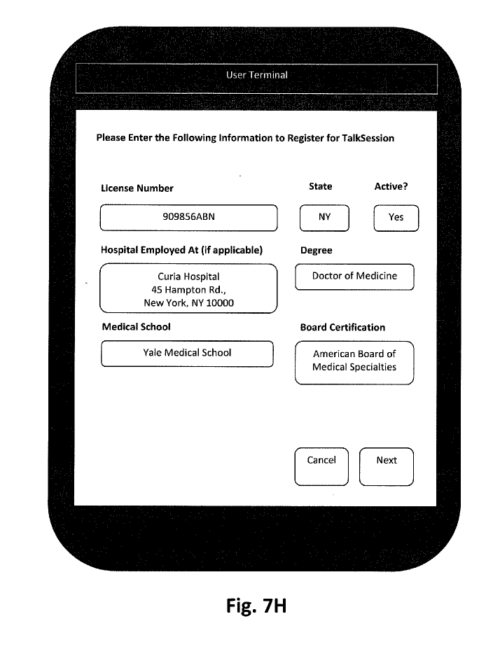

The patient, who may be suffering from a mental disorder or may be experiencing other wellness issues, or another user, can use the referral application 103a to search for wellness professionals who have the knowledge and experience to provide a proper treatment or a diagnosis to the patient. In order to commence such process with the referral application 103a, the user is requested to login to the referral application 103a, such as through the user interface screen shown in FIG. 7A. If the user does not have an account, the user can proceed to request an account by clicking on the “Click Here” button next to the question “Not Registered?”.

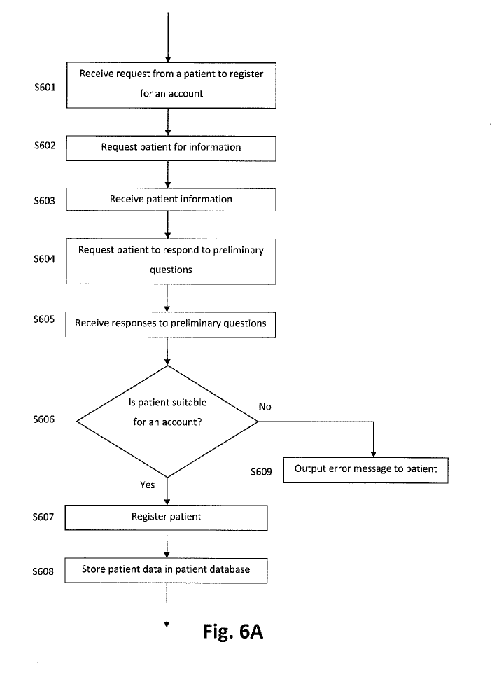

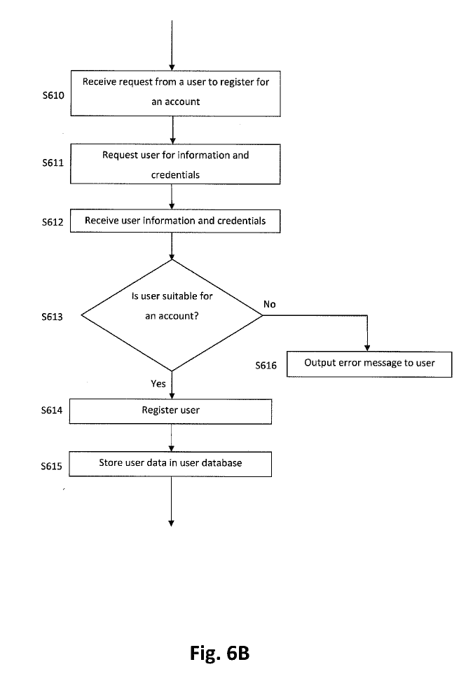

When the “Click Here” button is selected to request an account (S601 in FIG. 6A), a process, such as shown in FIG. 6A, to register the user for an account is triggered. Next, a series of user interface screens are presented to collect wellness data. For example, the user interface screen illustrated in FIG. 7B may be presented to request the user to indicate whether he or she is the patient or occupies a role other than patient. In the example shown in FIG. 7B, since the user is the patient, the user marks the radio button corresponding to “patient” and clicks “next”. The referral application may then request the user to enter PHI (protected health information) of the patient (step S602), including, but not limited to, name (on the other hand, if the user were someone other than the patient, the user interface may request the user to identify the patient by name or by some other means of identification, such as an identification number), age, gender, contact information (e.g., e-mail address, residential address, phone number, fax number, etc.), preferred contacting method (e.g., e-mail, texting, video chat, voice-only chat), preferred language of communication (e.g., American English, Canadian French, Mexican Spanish, Sign, etc.), etc., as shown by way of examples in FIGS. 7C and 7D. Other information may also be required optionally, such as insurance information, indication of a disorder or issue the patient has previously or is currently experiencing, whether the patient has been in therapy before, their favorite magazines, words to describe the patient, etc.

It should be appreciated that the user interface screens shown herein are merely examples. In many instances in which the entry of information is requested, the user interface can alternatively request the user to select (e.g., via dropdown lists, scrollable lists, etc.) listed values for assorted variables and/or types.

After receiving the PHI (step S603), the referral application 103a may output a set of preliminary questions for the patient to answer (step S604), as shown by way of examples in FIGS. 7E and 7F. These questions correspond to the information previously entered by the patient. For example, if the patient speaks only Canadian French as a language, is from Montreal, prefers video chat, and has bipolar disorder, the questions might be asked in (a) video chat format including audio and visual based (e.g., a pre-recorded message of a real-person asking the questions); (b) Canadian French, using terms and phrases familiar to residents of Montreal; and (c) a manner directed to obtaining pertinent information from patients with bipolar disorder. The patient may respond to these questions orally through a speech interface, and the referral application 103a records each answer. On the other hand, a patient may speak English and German, be from California, prefers only speaking and texting (and not video chat), and is depressed. In this case, the questions might be asked in (a) an audio and text format; (b) English and German; and (c) a manner directed to obtaining pertinent information from patients with depression. The reason for asking the questions in both audio and text and English and German is to obtain more data on the patient to analyze.

During the preliminary question period, the referral application 103a may concurrently collect biometric data of the patient. For example, the biometric data may include, but is not limited to, heart rates, blinking rates, facial movements, gesticulations, emotional displays, bodily movements, degree of tremors, trapezius muscle EMG (electromyographic) activity, temporal lobe blood flow, pupil movement/dilation, fingerprints, galvanized skin temperature, general vital signs, perspiration level and temperature, gait and weight distribution, local muscle activation motion and toned assessment, time and length a user expresses an emotion (e.g., crying, smiling, frowning, laughing, etc.), etc. The biometric data can be used to help determine disorders or other wellness issues that the patient currently has. Some of the biometric data obtained from patient during the preliminary questioning can be obtained using basic functionalities of a mobile device with proper hardware features to analyze the data. For example, blinking rates, facial and bodily movements can be determined from the videos or images recorded using the camera utility found in most devices. By using video or image processing to analyze the blinking rates, facial and bodily movements, the referral application 103a can determine the probability that the person has a particular disorder (e.g., depression, anxiety, etc.), an underlying medical condition, psychological condition, etc.

In addition, other biometric data such as brain functioning data which includes but is not limited to function magnetic resonance imaging (fMRI), positron emission tomography, magnetoencephalography nuclear magnetic resonance spectroscopy, electrocorticography, single-photon emission computed tomography, near infrared spectroscopy (NIRS), event-related optical signal (EROS), etc. Since the user terminal 101 may not necessarily have the features and tools to be able to obtain the previously mentioned biometric data, an additional device, such as a headgear connected to the user terminal 101, may be able to do so.

After receiving the PHI, the answers to the preliminary questions and the biometric data obtained (step S605), the referral application 103a makes a determination if the patient is suitable for further utilization of the application (step S606). If the patient is not suitable for further utilization, a message is output to the patient saying so (step S609). There may be various reason why an account may be denied. For example, inadequate information was supplied, it is determined from the address information of the patient that it would be unlawful to provide a referral through the Internet to anyone at that venue, the patient has a wellness condition that is not amenable to treatment or therapy remotely, etc.

On the other hand, if the patient is suitable, the referral application 103a registers the user to an account (step S607) and provides the user with credentials (e.g., username and password), as illustrated by way of example in FIG. 7G, or alternatively requests the user to create his or her username and password. The information previously entered by the user, the answers to the preliminary questions, the biometric data and the username/password are registered in association with the user in the patient database 104 by the patient-to-professional matching apparatus 103 (step S608). Such registered data may be referenced when performing a search for wellness professionals to match to the patient.

On the other hand, if the user indicates, in the user interface screen shown in FIG. 7B, a role other than patient, such as psychiatrist, physician, nurse, assistant, social worker, other person associated with the patient, etc., the process shown in FIG. 6B is performed by the referral application, to register the user who is not the patient for an account. There are many reasons for a user other than a patient to obtain an account. For example, a psychiatrist or other physician may need to find a specialist for the patient, and the referral application 103a would be useful for quickly finding other wellness professionals who are better suited for the patient. Another example is that it might be the case that the psychiatrist or physician is too busy to perform such a search and instead requests a nurse, assistant, social worker, etc., to perform the search instead.

In any event, in the process illustrated in FIG. 6B, the user is requested to log-in and can request to register for an account by selecting Click Here in the login screen illustrated in FIG. 7A. After receiving the request (step S610), the referral application 103a displays a screen (FIG. 7B) requesting the user to indicate a role of the user. In this case, the user may be a physician, the referral application 103a requests the user for two sets of information (step S611). The first set of information requested is similar to those of the patient, such as shown in FIG. 7C, e.g., name, contact information, gender, age, etc. The second set of information pertains more to the credentials of the user. For example, in this case the user is a physician and consequently, the user should be verified to be a certified practicing professional under the law. To facilitate this verification, information regarding the credentials and affiliations (e.g., license number, hospital employed at, medical school, board certification, degree, etc.) of the physician may be requested, such as by way of the example illustrated in FIG. 7H. The referral application 103a may use this information in conjunction with the first set of information obtained previously in verifying that the user is truly a physician and thus make a determination if the user is suitable for an account. For example, the referral application 103a may cross reference the information obtained with records at a hospital, university, a licensing board, government records, etc. In the case that the information has been verified (step 613, yes), the referral application 103a registers the user (step S614) and stores the information regarding the user (step S615). Otherwise in the case that the user is not verified as a legitimate physician or person (step S613, no), the user is denied an account (step 616).

In another example, the user may be a secretary and in a case in which the secretary is employed by a physician or other wellness professional, the secretary may register for an account as well. To facilitate this, the secretary may input information regarding the wellness professional she is working under. This verifies that the secretary is suitable for an account. However, the secretary may not be able to access all of the functions of the referral application 103a nor is the secretary allowed to access all of the information provided by the referral application 103a.

The Health Insurance Portability and Accountability Act (HIPAA) of 1996 prevents unauthorized persons from accessing PHI (protected health information) of a patient. HIPAA further protects any information that is defined as “individually identifiable health information”. This is any information that includes (a) the patient's past, present or future physical or mental health or condition, (b) the provision of health care to the patient and (c) the past, present, or future payment for the provision of health care to the patient. There can be legal problems if any persons other than the physician of the patient being currently treated obtain the PHI. In addition, HIPAA also mandates that all electronic devices including hardware and software be implemented in a way to secure the PHI. To ensure that such legal issues do not occur, the referral application 103a inquires the role (e.g., physician, nurse, secretary, social worker, etc.) of the user who is requesting an account. Then, the referral application 103a determines whether the information the user entered for verifying the role of the user is correct. In the case that the role of the user is verified, the referral application 103a allows the user to use the referral application 103a with the scope of access corresponding to the role of the user.

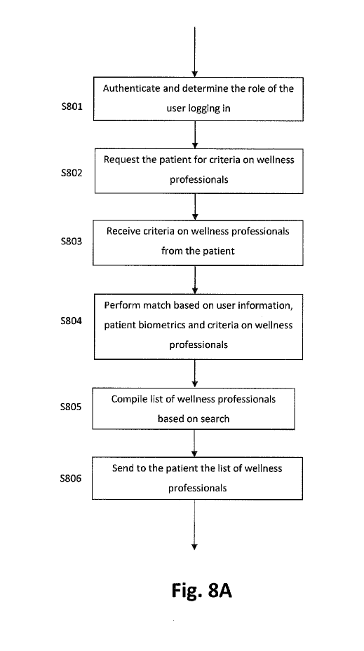

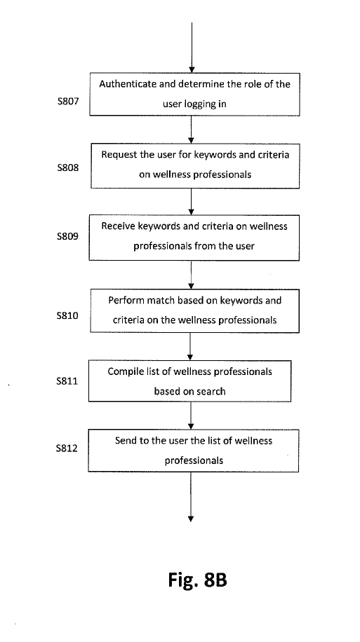

FIG. 8A show another process that can be performed by the referral application, for a patient to obtain services from a wellness professional, according to an exemplary embodiment.

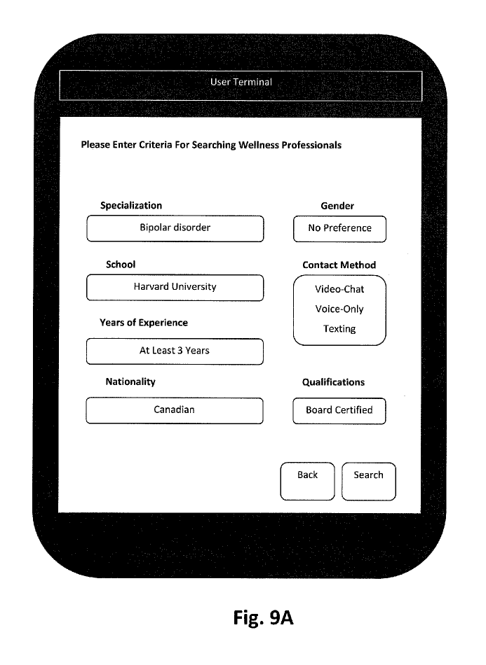

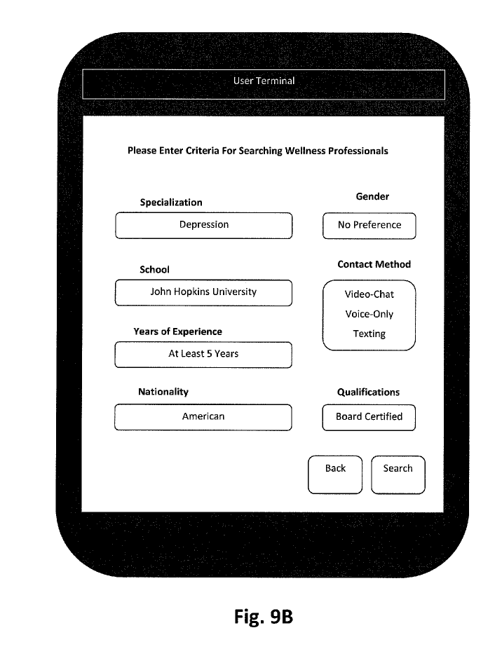

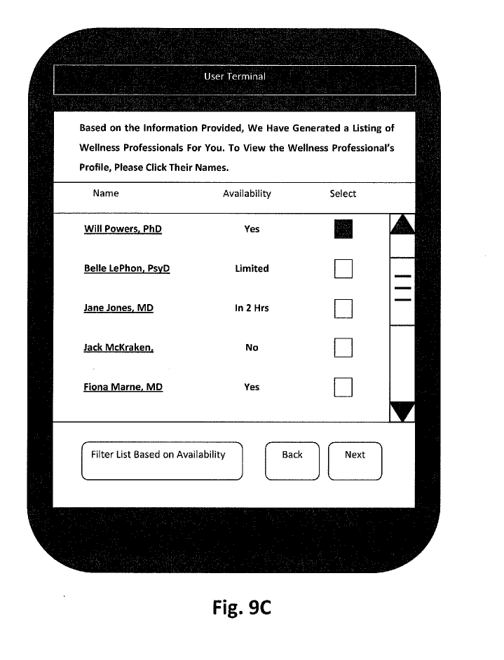

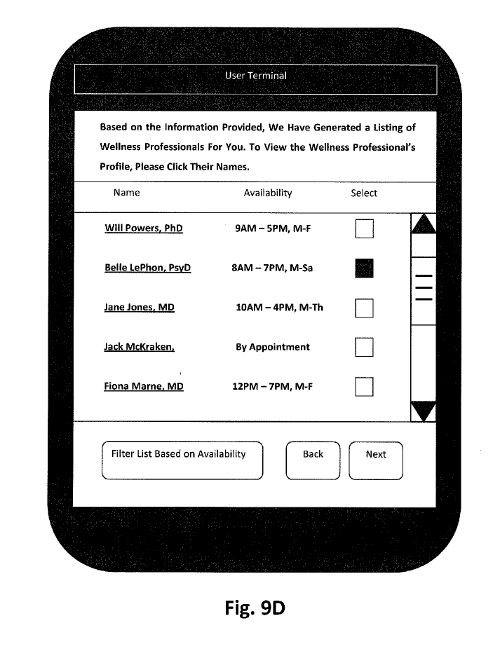

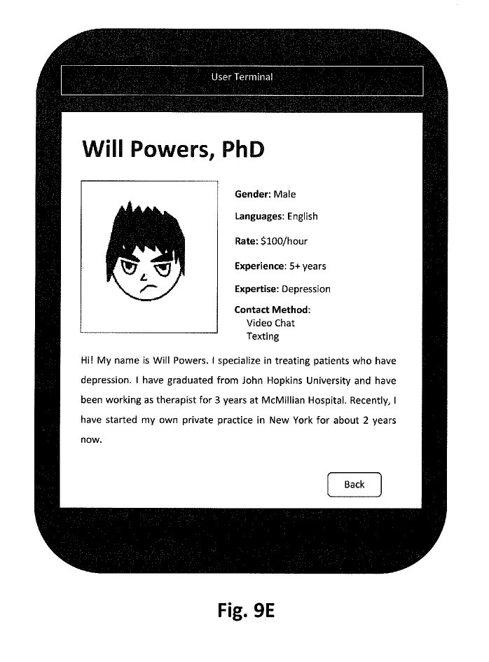

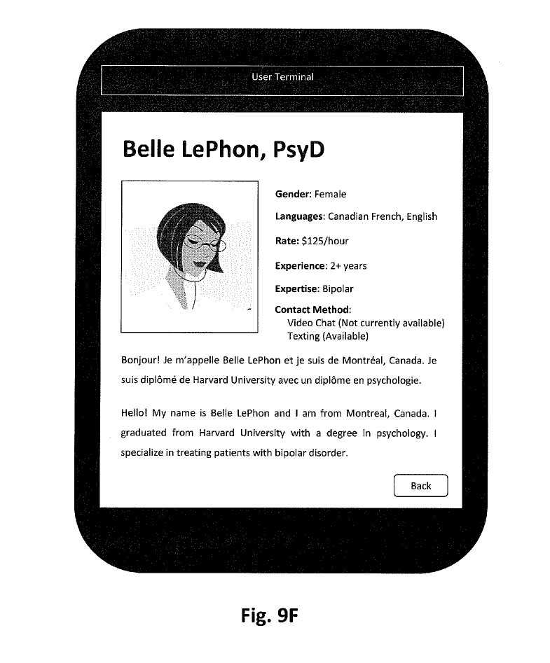

The referral application 103a first authenticates a user who has performed a login (step S801). Simultaneously, the referral application 103a also determines whether the user is a patient in order to comply with HIPAA. Then the referral application 103a requests the patient to enter additional criteria for selecting a wellness professional (step S802), such as through the user interface screens shown by way of examples in FIGS. 9A and 9B. Such criteria may include, for example, gender, qualifications (e.g., school, licensing, certification, years of experience, etc.), specialization, nationality, etc. Such criteria helps to narrow the search even further in order to select the wellness professional that best matches the patient. Further, such process allows the patient to specify criteria targeted to wellness professional with whom the patient would feel more comfortable to communicate. For example, a patient may feel more comfortable conversing with a wellness professional who has a degree from a reputable institution and has ten-plus years experience.

After receiving the information (step S803), the referral application 103a utilizes various wellness data, such as PHI (protected health information), biometric data, etc., collected previously or concurrently, and the wellness professional criteria information to perform a search using the wellness professional database 106 (step S804). For example, the patient may have entered that she has bipolar disorder and wants to see a wellness professional who has experience treating such condition. However, during the preliminary questioning phase of the registration, the referral application 103a picked up biometric data that pointed to the patient having a high probability of having depression. In this case the patient may not know that she may have depression as well as bipolar disorder. The referral application 103a may search for wellness professionals who have expertise or have experience with patients with bipolar disorder and/or depression. Once the search is completed, referral application 103a compiles a list of the wellness professionals which correspond to the information that the patient had entered previously and the data taken by the referral application 103a (step S805), as illustrated by way of examples in FIGS. 9C and 9D and sends the list to the patient (step S806).

Even if wellness professionals are matched to the patient, they may not be suitable for the patient. For example, a wellness professional may be licensed to practice in New York, but not in California, which is where the patient is from. As a result, the referral application may not place that particular wellness professional on the list. As shown in FIG. 9C, the user is shown information such as name and availability of each wellness professional. FIG. 9D is another exemplary embodiment of the information shown in FIG. 9C and shows similar information as well. In this case, the information shown indicates the schedule of the wellness profession. For example the wellness professional “Belle LePhon” works from “8:00 AM to 7:00 PM” and on “Mondays-Saturdays”. Further, the user may click on each name of the wellness professional to access their profiles. Typical information shown in the profiles of each wellness professional include name, professional degree, gender, location, languages, availability, years of experience, contact information, availability, etc., as shown by way of example in FIGS. 9E and 9F.

However, the wellness professionals on the list may shift between being available and not available (e.g., busy, finished working, on vacation, etc.) as the list is updated real-time. For example, a wellness professional may be busy for the time being but may be available in “2 hours”. This would be output to the display on the user interface 101a of the user terminal 101. Thus the patient can choose to wait for the wellness professional to be finished before contacting him or her. Further, the list may show that the wellness professionals may be available on one mode of communication and not available on another mode of communication at the same time.

For example, a wellness professional, whose contacting method may include voice calls and video chats, may be listed under available for voice calls, but is not available for video chats. This is possible since the terminal the wellness professional is currently using may have a broken camera. Thus, the wellness professional is unable to communicate via video chat until the camera is fixed. In another example, it may not be convenient for the wellness professional to use video chat at the moment and thus may only accept requests through text. Nevertheless, the list shows all wellness professionals who are available and unavailable. Alternatively, the patient may have the referral application 103a filter the list to show only the wellness professionals who are available. After the list has been filtered, the patient merely browses through the list and selects a wellness professional.

In another exemplary embodiment, the search may be performed without inputting any criteria related to the wellness professional. Further, the search may also be performed without relying on any prior or current information (e.g., PHI, biometric data, etc.), and instead, the patient may input words, sentences, phrases, acronyms, etc. into a natural language search box which is provided by the referral application 103a. In this case, the natural language search box allows the patient to input sentences or phrases which are commonly used by people. Thus, it is not required to input exact keywords and phrases. The user may put in words such as “I” or “please” that may not be pertinent to the disorder that the patient is seeking treatment for, but correspond to proper English grammar. For example, a typical search input might be “I have bipolar disorder” or “Please, help me. I need assistance with my bulimia”.

In an exemplary embodiment, the referral application 103a may use the Internet Protocol (IP) address of the patient in conjunction with the search input to perform the search for wellness professionals. For example, an IP address of a user “Francoise” may correspond to a location in Montreal, Quebec. Thus, the referral application 103a may not only compile a list of wellness professionals who are best suited for treating Francoise's disorder, but the referral application 103a may also include in the list of wellness professionals who are near or in Montreal. Further, since Montreal is a French-speaking city, the referral application 103a may include in the list, wellness professionals who can speak French as well.

In another exemplary embodiment, the referral application 103a may use, in addition to the search input, information obtained without user interaction to perform the search for wellness professionals. Such information may include, but is not limited to, environment, location, biometrics, etc. and can be obtained through various means such as data received from the Internet (e.g., local news forecast, temperature, etc.), GPS system, a device on the patient that detects heart rate, etc. After receiving the search input from the patient, the referral application 103a then obtains the information mentioned previously and compiles a list of wellness professionals.

In another exemplary embodiment, the referral application 103a may also request further user input in order to perform a search for the wellness professionals who best match the patient. In this case, there may more than one patient. This is possible in case in which the patients are couples or family members. Thus, due to the greater number of patients trying to obtain access to the same wellness professional, the referral application 103a may need to know more about each patient. To facilitate this, the referral application may prompt the patients to answer additional questions based on a variety of factors. Further, the patients may be also prompted to allow the referral application 103a to access one or more data sources (e.g., social network API, medical exchange date, etc.) that is deemed necessary in order to make an appropriate and relevant match.

Further, referral application 103a may be configured to generate wellness indices determined based on the wellness data input into referral application 103a. Such wellness indices may be matched to indices assigned to the wellness professional, by direct comparison, or after applying some processing, such as a mask, weight coefficients, etc. For example, weighted indices may used to afford more weight to more relevant attributes and determine an ideal wellness professional possesses which best matches the patient.

FIG. 8B shows another process that can be performed by the referral application, for a user who has a role other than as a patient (e.g., physician, nurse, social worker, secretary, etc.), to obtain services from a wellness professional, according to an exemplary embodiment.

The referral application 103a first authenticates a user who has performed a login (step S807). Simultaneously, the referral application 103a also determines the role of the user in order to comply with HIPAA. That is, the referral application 103a performs this determination to prevent an unauthorized user from accessing PHI of another. To ensure maximum security, a user who is a physician may be requested to input information in addition the username and password. Such information may include, but is not limited to, the medical license number, driver's license number, hospital identification number, etc.

After performing the determination, the referral application 103a requests the user to input keywords and criteria for the wellness professionals (step S808). The keywords may include anything related to the patient's condition such as “bipolar disorder”, “insomnia”, “depression”, “post-traumatic stress disorder”, etc. Further, the referral application 103a may also request the user to input criteria on the wellness professional, as previously discussed and shown by way of example in FIGS. 9A and 9B. For example, these criteria may include gender, qualifications (e.g., school, licensing, certification, years of experience, etc.), specialization, nationality, etc. One of the reasons for requesting the patient to enter this criteria is to narrow the search even further in order to select the wellness professional that best matches the patient. Once the referral application 103a receives the information requested from the user (step S809), the referral application 103a performs a search from the information received (step S810). After performing the search, the referral application 103a compiles a list of wellness professionals (step S811) and sends the list to the user (step S812).

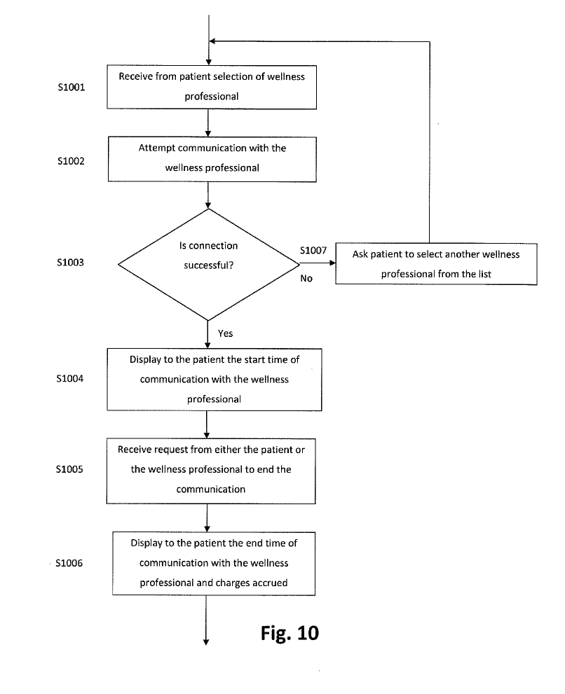

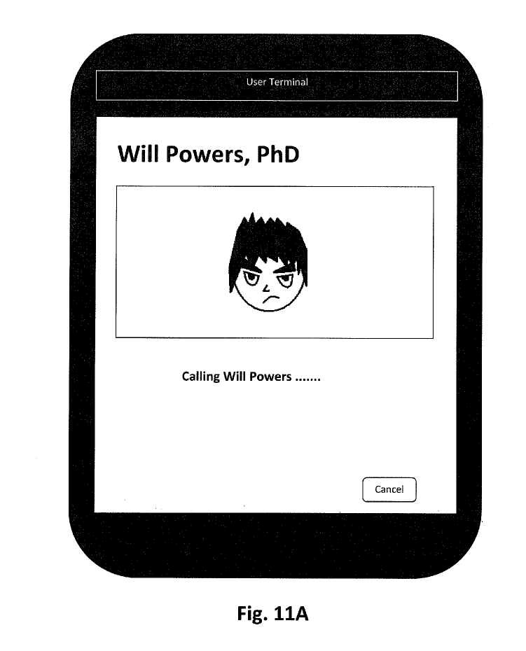

FIG. 10 shows another process that can be performed by the referral application, for connecting a patient with a wellness professional, according to an exemplary embodiment.

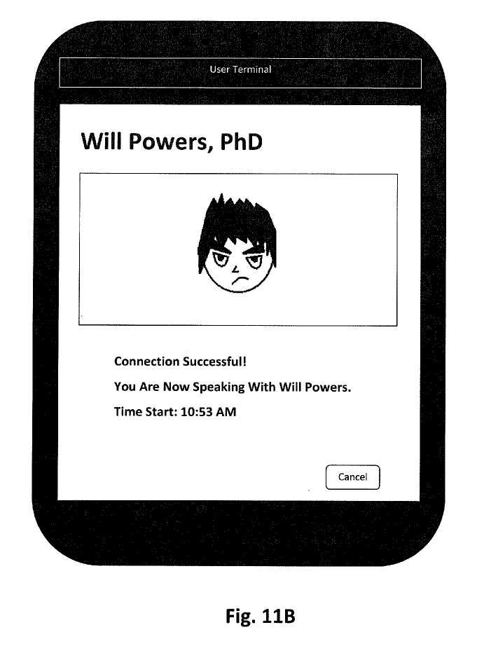

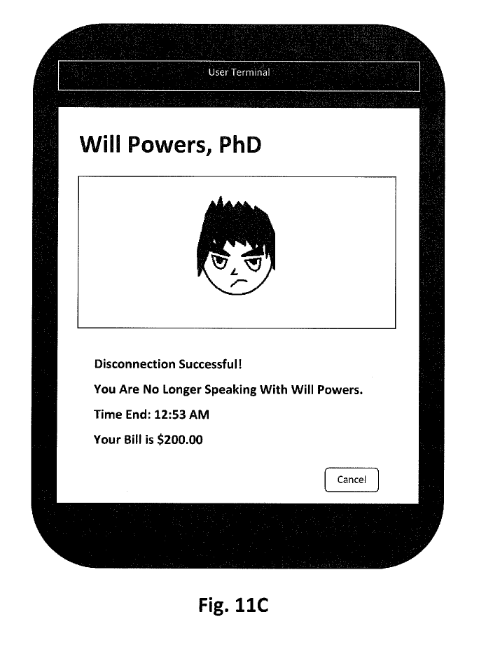

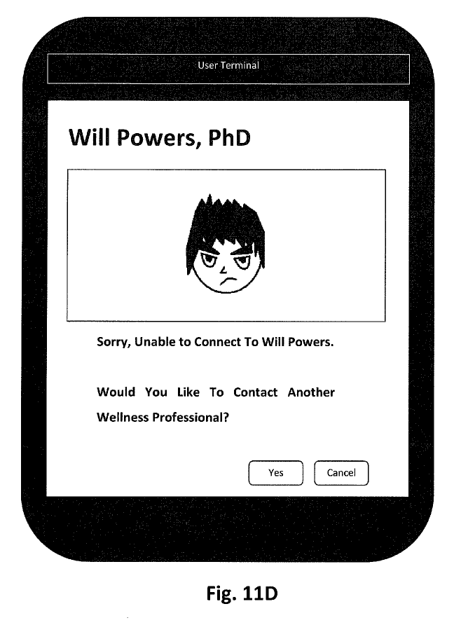

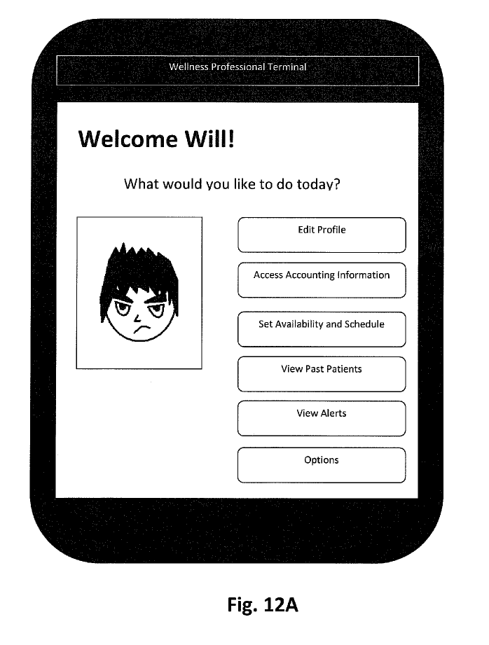

Once the patient selects a wellness professional, the patient may contact the wellness professional through the use of the referral application 103a (step S1001). Alternatively, the patient may perform any method of contact which is suitable for both the patient and the wellness professional. Although in this case it is assumed that the patient is contacting the wellness professional through the use of the referral application 103a. Next, the referral application 103a may attempt to connect with the wellness professional (step S1002), as illustrated by way of example in FIG. 11A. In the case that the connection is successful, the patient can start to communicate with the wellness professional (step S1003, yes). After the connection is established, the patient is shown the time that session with the wellness professional begins (step S1004) as shown in FIG. 11B. In the case that the connection is unsuccessful (step S1003, no), as shown by way of example in FIG. 11D, the patient is requested to select another wellness professional (step S1007). Once the session between the patient and the wellness professional is completed, either the patient or the wellness professional may end the session (step S1005). The patient is then shown the time that the session has ended and how much charge has accrued (step S1006) as shown by way of example in FIG. 11C.

In an exemplary embodiment, the charge accrued may not be charged after the session is over but before it. For example, the wellness professional may request the patient to confirm an amount of time for a session (e.g., 1 hour, 2 hours, 3 hours, etc.) and have the patient pay an amount corresponding to that amount of time (e.g., $125/hour). Thus, for a patient who pays an amount such as $250.00 in advance, he or she may only have 2 hours to speak with the wellness professional. When the session reaches 2 hrs, the session may automatically terminate.

In another exemplary embodiment, the user contacting the wellness professional may not be a patient. In this case, the user may be a wellness professional. In such instance, the user, for example, who is a wellness professional may request another wellness professional for his or her patient since the user may not be experienced enough to treat a certain condition his or her patient is currently having. Consequently, the user may refer the patient to another wellness professional for an opinion or advice. In another possible circumstance, the user may request another wellness professional to confirm the diagnosis by the user.

In another exemplary embodiment, the patient may not want to select a wellness professional from the list. In this case the referral application 103a may perform the selection for the patient. Thus, when the referral application 103a performs the search, the patient is immediately shown a profile of a wellness professional that most closely and best matches the patient. The patient can then communicate with the wellness professional.

In another exemplary embodiment, when performing a search for the wellness professionals, the referral application 103a may utilize the data of previous patients to make determinations. For example, data of all patients including the current patient which is stored in the patient data 103b is compared with each other on a common plane. Then a grouping algorithm that determines which of the previous patients are similar to each other is performed. The comparison can be based on a variety of factors including, but not limited to, name, age, gender, residential location, insurance information, preferred contacting method (e.g., texting, video chat, voice-only chat, etc.), preferred language of communication (e.g., Hindi, Persian, Arabic, etc.), the mental disorder/issues the patient has previously/is currently experiencing, etc. After running the grouping algorithm, each of the patients is divided into subgroups such as, for example, “Indian males under 20”. From each of the subgroups, statistics such as medians, norms and deviations can be extracted. These statistics becomes the dynamic indices.

Next, a set of previous data that matches each subgroup is imposed over the indices previously generated and a treatment is ranked based on an average thereof. The previous data may be the data of the wellness professionals, such as, for example, treatment success with a patient having certain parameters. From that, density is ranked based on the number of wellness professional attribute success within each subgroup. These are the weighted data points which have the most likely possibly of success. The weighted data points are measures which show that a wellness professional with these attributes may best fit a patient subgroup. Next, the weighted data points are imposed upon each subgroup in order to analyze how the weighted data points affect with each one. Next, the number of patient occurrences may be tallied. The weighted data points which produce the best attribute set is selected. Thus, the patient is shown a list of the wellness professionals which correspond to this attribute set.

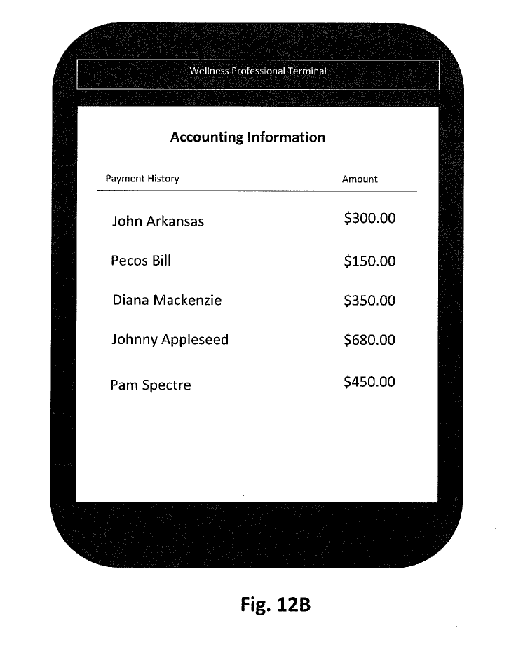

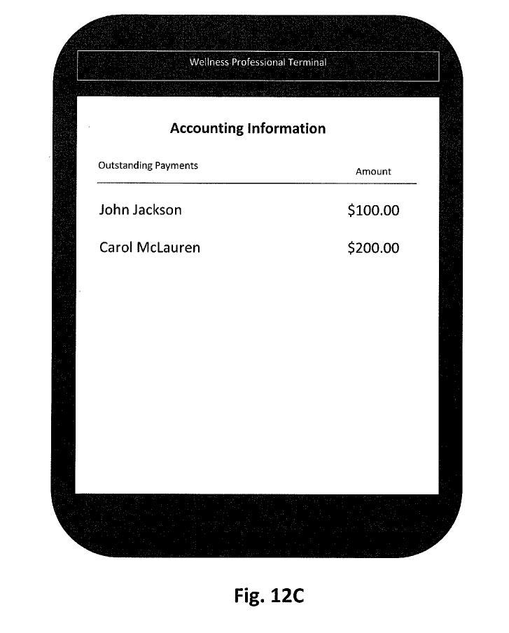

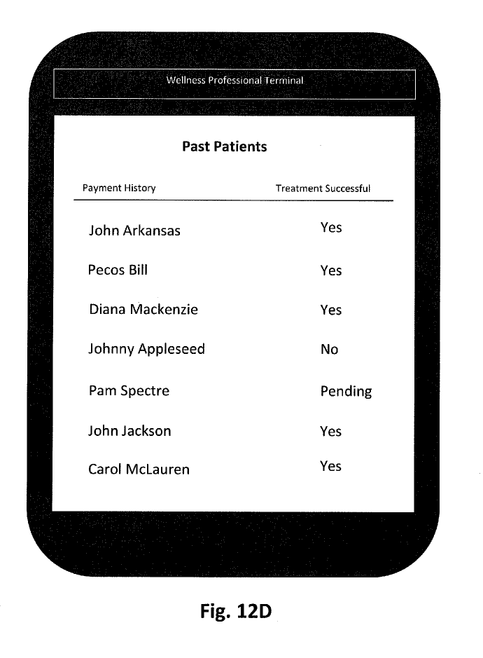

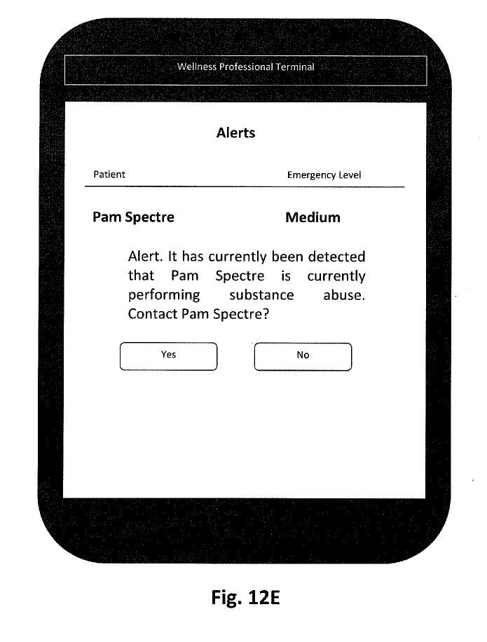

FIGS. 12A-12E are examples of user interface screens that can be shown on the wellness professional terminal.

For example, in FIG. 12A, the wellness professional is provided choices of editing his profile, accessing his account information, viewing past patients and setting his availability. In FIG. 12B, the wellness professional is viewing the billing history of payments made to his account. As shown the list contains the names of past patients and their payment charges. In FIG. 12C, the wellness professional is viewing outstanding payments of his patients. The patients in this case may have had a session with the wellness professional already, but however have not made any payments yet. In FIG. 12D, the wellness professional may view the past patients that he has treated. As can be seen, the wellness professional may also check whether the treatments on those patients were successful, not successful or currently pending.

In an exemplary embodiment, the wellness professional may also receive alert notifications from a patient's terminal to initiate a session with the patient, as illustrated in FIG. 12E. This occurs when the situation may dictate the necessity for contextual information to be relayed to a specific provider, a group of providers, an administrator, and/or patient whereby subsequently or in conjunction to that information dissemination, a patient is prompted with a match or with a message because either their social, environmental or otherwise recognized contextual data that prompted a need for care. For example, the patient may have known history of substance abuse. An available technology with a transdermal skin patch (i.e. a device that can detect alcohol in sweat) may recognize the presence of the substance and will relay it to the referral application 103a. In the case that this occurs, the referral application 103a may inform the wellness professional to initiate a session with the patient.

In another exemplary embodiment, the referral application 103a may determine that the information gathered or collected showed that the population was receiving an alert (e.g., AMBER Alerts via SMS, crisis news alert which necessitates mobilizing the population, etc.). Thus, the referral application 103a may detect population-based situations detected by outside parties and respond with a prompt for “check in” and/or mandatory sessions with a provider or inquiring as to whether the patient would like to request a session with a wellness professional.

In another exemplary embodiment, the environmental factors may also lead the referral application 103a to warn the wellness professional of actions that require physical intervention. Such environmental factors may include but are not limited to noise (e.g., ambiance, background, etc.), weather, local news, regional and local demographics, air quality levels, location to other radio frequency emitting device/communication signals, time of day, surrounding social groups (e.g., hipsters, elites, low income, conservatives, liberals, etc.).

In another exemplary embodiment, social factors may also be considered, such as psychosocial data from 3^{rd} party APIs (e.g., social networking sites, apps, etc.), physical tracking data (e.g., weight, movements, locations, etc.), photo-related data (e.g., locations, other parties, image recognition on type of environment, etc.), frequencies of interactions, self-proclaimed data through specific inputs or natural language assessments (e.g., internet feeds, social networking updates, etc.), social cues (e.g., social isolation, not making calls or keeping in touch with contacts, differentials in length of time spent with individual, etc.). Further, data based on the communication between various people and the conclusions made from that analysis can be made without regard to content. For example, sexual orientation can be reasonably determined based on an analysis of communications.

In another exemplary embodiment, the required wellness service for the patient may be inferred from contextual information. If the patient does not respond to push notifications, a procedure may be in place to contact someone related to that person to intervene or further assist the person in need of help. For example, the patient may have a history of attempted suicide. Information obtained from the patient terminal indicates that the patient is on a building at a level of ten stories near a location that the patient previously tried to commit suicide. However, to confirm that the patient is actually trying to commit suicide, the referral application 103a may cross reference other data such as galvanized skin temperature or pulse rate. In the case that the referral application 103a determines that there is a high probability that the patient is trying to commit suicide, the referral application 103a may attempt to prompt or contact the user directly through a push notification mechanism or contact a wellness professional, family members of the patient, a local emergency resource or parties within the defined location of the patient to alert them.

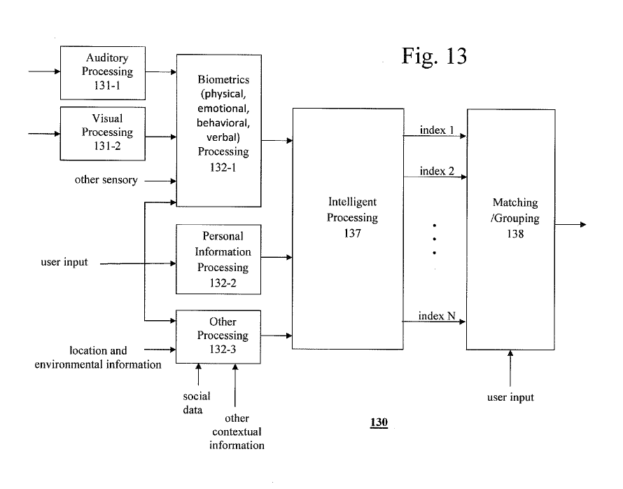

As pointed out supra, the matching process may apply artificial intelligence (AI) techniques or other intelligent processing. For example, intelligent matching module 130 shown in FIG. 13 may be integrated in the referral application.

In the intelligent matching module 130 shown in FIG. 13 includes intelligent processing part 137 and matching/grouping part 138 as core components, and additionally includes auditory processing part 131-1, visual processing part 131-2, personal information processing 132-2, and other processing 132-3, to receive various wellness data, either live or retrieved from a database or other storage.

The input to the auditory processing part 131-1 may be a live audio stream or a recorded or captured audio stream, and the auditory processing part 131-1 operates as a speech or voice interface to extract words from the audio stream and natural language processing may optionally be applied. Such processing is generally well understood in the art and therefore a detailed description of audio processing is omitted here in order to avoid obscure inventive aspects of the present disclosure.

On the other hand, the input to the visual processing part 131-2 may be a live video stream or one or more still images, or a recorded or captured video stream or images, and the visual processing part 131-2 operates as an image processing and/or video processing unit to extract visual attributes (e.g., facial muscle orientation and movement, eye blinking rate, body tics, gait and weight distribution, local muscle activation motion and tone assessment, facial expressions such as crying, laughing, smiling, frowning, etc.) of the patient. Such visual processing is also know in the art and therefore a detailed description of audio processing is omitted here.

The outputs of the auditory processing part 131-1 and the visual processing part 131-2 are fed along with user-input data and other wellness data, streamed, recorded or captured, from various other sensors, which detect, e.g., skin temperature, general vital measures, perspiration level and temperature, etc., as inputs into biometrics processing part 132-1. The biometrics processing part 132-1 applies AI (e.g., one or more artificial neural networks, etc.) and/or other intelligent (e.g., rule-based) processing to characterize the combination of inputs into physical, emotional, behavioral, verbal attributes. Such attributes may be coded and output in any of a number of possible structured formats that establish such different possible outputs of the biometrics processing part 132-1 on a common plane for input into the intelligent processing part 137.

The personal information processing part 132-2 processes user input personal information (current or archived) and extracts notable attributes. That is, not all of the user input personal information would be notable, and one personal information may be notable only. Such notable attributes are output in a structured manner to the intelligent processing part 137.

Likewise, the processing part 132-3 processes other input data such as location and environmental data (e.g., ambient or background noise, weather, local news, regional and local demographics, air quality, proximity to other radio-frequency emitting devices and signals, time of day, etc.), social data (e.g., extracted from social media, self-proclaimed, physical tracking data, native photos, interactions in-person and over electronic media, etc.), along with user-input information to extract notable attributes, and outputs the notable attributes in a structured manner to the intelligent processing part 137.

The intelligent processing part 137 processes the attributes received from the biometrics processing part 132-1, personal information processing part 132-2 and other processing part 132-3, and outputs wellness indices 1 . . . N (≧1) which encode the combination attributes received by the intelligent processing part 137. The intelligent processing part 137 may apply any one or more AI and other intelligent processing techniques. For example, the intelligent processing part 137 may include an artificial neural network, or another intelligent part, trained by applying machine learning techniques. Such machine learning techniques are generally understood and therefore a detailed description of audio processing is omitted here in order to avoid obscure inventive aspects of the present disclosure.

The wellness indices are processed by the matching/grouping part 138. This end stage of the intelligent processing can be configured in any of various manners. For example, each wellness professional may be assigned a vector of indices characterizing the wellness professional. The combination of wellness indices may be compared (e.g., via vector processing) to the vector of indices of each wellness professional, to determine a match. In some instances, it may be desirable to have an exact match. In other instances, the “match may be based on a threshold. in yet other circumstances, it may be desirable to apply a mask or weights or coefficients in the vector processing. Such matching may be controlled by user-input, and/or wellness data or other data received through the front stage. For example, a function may be applied to any combination of inputs of the intelligent matching module 130, to determine the aforementioned threshold, or to determine a mask for the vector processing. As another example, the threshold or mask may be selected based on the attributes input into intelligent processing part 137.

As another example, the matching/grouping part 138 may perform self-organization or clustering to the wellness professionals to form groups of professionals. Such grouping may be performed in advance and may be characterized and/or may be modified by the user. The group of wellness professionals may be assigned a vector of indices which characterizes the group. In one example, the matching is performed with respect to the group and all of the wellness professionals of a matched group are presented to the patient as candidate wellness professional matched to the patient.

In another example, two levels of matching are performed. First, group matching is performed to eliminate groups of wellness professional. Next, individual matching is performed with respect only to wellness professionals in the matched group(s).

As mentioned above and as is known in the art, training and machine learning are often conducted to improve performance of Al and other intelligent processing modules so that the module can operate adaptively, as needed, and such training and machine learning may be supervised or automated, offline and/or on-line.

Accordingly, many parts (e.g., intelligent processing part 137, matching/grouping part 138, biometrics processing part 132-1, etc.) of the intelligent matching module 130 may have integrated therein a learning module (not shown in FIG. 13). Such a learning module can adjust the inner logic of the host part, when the module identifies that an attribute (e.g., personal information, biometrics, wellness professional preferences, etc.) of the patient or several patients, to lead to better matching of patient to professional when said attribute is relevant. As such, similar adjustment can be made iteratively in order to make the referral application 103a more accurate in its matching.

In one example, adjustment by the learning module is performed off-line in a testing environment. Data from previous patients are accumulated (along with desired results) over time and applied in the test environment by learning module in order to train the subject intelligent part to obtain the desired result. In other words, the input data (e.g., patient data, wellness data, etc.) may have a corresponding expected or desired output and when the input data is input into the subject intelligent part, the learning module can formulate an adjustment based on comparison of the actual output of the learning module to the expected or desired output, in an effort to drive the actual output to converge on the expected or desired output.

For example, it may be determined in advance that a patient “John Smith”, who has certain attributes (e.g., speaks French, has depression, lives in Quebec, etc.), best matches a wellness professional “Maggie Sue”, who can correspond to those attributes (e.g., can speak French, specializes in treating depression, and practices in Quebec). Thus, the output of the intelligent matching module when the input is “John Smith” should be “Maggie Sue”. On the other hand, in the case that the output of the intelligent matching module is not “Maggie Sue” when the input is “John Smith”, the learning module well make adjustments.

In addition, there may be multiple outputs. For example, the output for the input “John Smith” may not only contain “Maggie Sue”, but also “Jim Brown”, “Vincent Green” and “Lisa Quinn” as well. In this case, it should be determined if “Jim Brown”, “Vincent Green” and “Lisa Quinn” also match “John Smith” as well. For example, since “John Smith” is a patient seeking treatment for depression, the wellness professionals indicated by the output from the learning module are desirably able to treat patients having depression. In this case, the wellness professionals “Maggie Sue”, “Jim Brown”, “Lisa Quinn” are able to treat depression. However, “Vincent Green” is a wellness professional who has no experience or skills in treating depression. Instead “Vincent Green” specializes in anger management. Since anger management is obviously not depression, “Vincent Green” is clearly not the right match for “John Smith”. Thus, the learning module is configured to make adjustments.

The subject matter disclosed herein can be applied in any of numerous possible settings or locations.

For example, in a university setting, a student in need of counseling logs onto the patient-to-professional connection platform initially and in the registration process wellness data is collected by the system. The system determines from the collected data an age demographic range, that the user is a student, etc., and based thereon, including the factor that the user is a student, as well as other factors, such as timing (e.g., time of day, day of week, season of year or school year, etc.) of the sign-on, determines some of the variable weights and measurements. The intelligent system in such university (or other academic) setting steers itself based on such factors specific to the setting. Thus, in an example of a timing in which it is during the beginning of the semester, or during exam periods, the system is biased to account for potentially a higher level of stress than in other periods of time. Based on the collected wellness data, the platform calculates a wellness index of the user, in order to match the user to one or more highly relevant wellness providers. An example of such process is discussed below.

Various types of factors (e.g., school-related, physical-related, mental-related, social-related, environmental, etc.) can be processed in the example of a university setting. As an example of school-related factors, the area of study of a student is considered to be a significant factor contributing to the wellness profile of a student. Studies show that students pursuing a hard science major have significantly higher perceived levels of stress and have been found to have higher level of neuroses in addition to more natural introversion. Thus, the area of study of a user known to have a hard science major may negatively impact expected wellness.

Further, in another example of school-related factors, if it is a high-stress time within the academic calendar, a student's wellness index may naturally be lower, although such tendency may be applicable to all of the student's peers. Such factor may be of interest in a case that some of the providers are outside of the closed network of the university, in contrast to another example in which all of the users seek help from the same group of providers.

In addition, physical factors, such as BMI (body mass index), can influence the wellness index. For example, higher BMI typically correlates to a lower wellness index. Further, history of regular check-ups can project positively to the wellness index.

Mental-related factors are of course reflected in the wellness index. Various SMI (Serious Mental Illness) information may steer the wellness index. For example, a history of SMI is typically assigned high weight and can have indirect correlation with the wellness index. On the other hand, genetic SMI is afforded relatively lower weight, but still can have indirect correlation with the wellness index. It should be appreciated that reported level of contemporaneous mental distress would be assigned high weight and correlation. For example, higher mental distress correlates to lower expected wellness.

Social-related factors can correlate to wellness as well. For example, studies show that people in relationships have lower stress levels, which in turn translates to higher wellness, and in such instance, such factor is assigned low weight. As another example, competitive athletics are associated with higher pressure, relating inversely to wellness index as it relates to mental wellness.

In addition, environmental factors are well known to affect wellness. For example, higher level of acuity can translate to lower wellness. As another example, consultation requests at certain hours of the day (e.g., 1 a.m.-5 a.m.) correlates to a higher likelihood of acute distress, yielding a lower expected overall wellness index.

Such factors are applied in the following example.

### School-Related (Total Weight of Category: 0.2):

Area of study: Possible areas (in this example) include English, Sociology, Economics, Biology, Engineering, having associated scores of 5, 4, 3, 2, 1, respectively. For example, Engineering with a score of 1 indicates that the student's major correlates to the highest stress major amongst the possibilities. Weight of area of study within school-related category: 0.4.
Time of year: The system is configured to refer to the academic calendar, and to discern the predicted level of stress associated with academic-related events. Possible time periods include regularly scheduled classes, beginning of semester, exams period, having associated scores of 5, 3, 0, respectively. Weight of time of year within school-related category: 0.6.

### Physical-Related (Total Weight of Category: 0.10):

BMI: Possible inputs include significantly above average, above average, average, below average, significantly below average, having associated scores of 0, 2, 5, 2, 0, respectively. Weight of BMI within physical-related category: 0.25.
Perceived physical image (self-reported information, correlated to self-esteem): Possible user inputs to “I perceive my physical image as” include above average, average, below average, having associated scores of 5, 3, 0, respectively. Weight of perceived physical-image within physical-related category: 0.75.

### Mental-Related (Total Weight of Category: 0.50):

History of SMI: Possible inputs include no history of serious mental illness; past history of mental illness but not known to be current; current serious mental illness known, having associated scores of 5, 2, 0, respectively. Weight of SMI history within mental-related category: 0.3.
Reported level of mental distress at the time: User chooses own score, with possible scores being 0, 1, 2, 3, 4, 5, in which 0 represents feeling high level of distress and mentally unwell, 3 represents feeling average level of mental wellness/stress, 5 represents insignificant levels of distress and overall feeling mentally well. Weight of mental distress within mental-related category: 0.7.

### Social-Related (Total Weight of Category: 0.1):

Relationship status: This information can be self-reported and/or gathered through social media APIs in which the system pulls data that user has furnished to social media platforms. Possible inputs include in a relationship, not in a relationship, going through a breakup, having associated values of 5, 3, 0, respectively. Weight of relationship status within social category: 0.75.
Athletics: Possible inputs include varsity athlete, not an athlete, having associated values of 0, 5, respectively. Weight of athletics within social category: 0.25.

### Environmental (Total Weight of Category: 0.1):

Time of day as related to acuity: Possible periods include 7 a.m.-8 p.m., 8:01 p.m.-1 a.m., 1 a.m.-6:59 a.m., having associated values of 5, 3, 0, respectively.

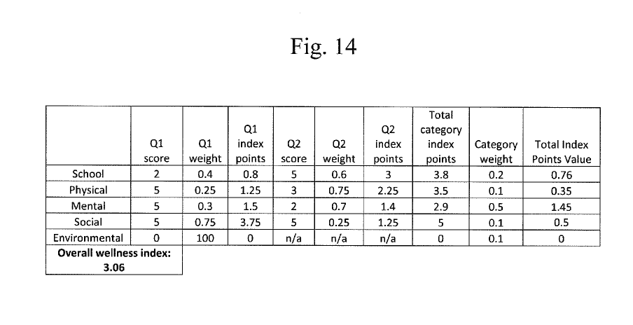

FIG. 14 shows a tabular summary of the wellness index calculation, in this example, for a student-user Anna Smith, who is a biology major, is calling within middle of regularly scheduled semester, has an average BMI (according to system's connection to user's reported health profile), claims to have an average perceived body image, has no history of SMI, reports a 2 on the reported level of mental wellness scale, is in a relationship, is not an athlete, and is calling at 2 a.m.

As shown in FIG. 14, the wellness index calculated for Anna Smith is 3.06. Such wellness index can be applied to choose the best match or rank the pool of applicable providers. As should be appreciated, such example is merely one possibility, discussed for illustrative purposes. In other examples, under the university setting or another setting, the categories, weights, indices, etc., may (and likely would) be different.

In a correctional setting, inmates often have wellness issues. Unfortunately, although there may typically be some wellness professional at the correctional location, the professional is generally not a specialist, and to the extent that the professional is a specialist, the chances of the needs of a prisoner matching the specialty of the professional are remote. Further, such inmate of course does not typically have the freedom to travel to visit a qualified wellness professional off site (except under extenuating or other special circumstances), and such qualified wellness professional off site is unlikely to travel to meet with the prisoner at the correctional facility.

The tools disclosed herein can be employed to enable a connection between the inmate and a suitable wellness professional, and then to allow the wellness professional to conduct any one or more of initial evaluations, treatment, forensic evaluations, substance abuse treatment plans, treatment upon discharge from inpatient care to maintain continuous care, treatment from “home” provider (i.e. on-site), instructional dialogue regarding discharge plan and/or conduct, communication with court systems and/or representatives from court systems, attorneys, parties related to inmates case, and/or family members, check-ins with correctional facility associated parties and/or wellness providers after discharge.

In some correctional settings, in-house behavioral health specialists are in short supply, and therefore there is pressure in such correctional setting to transport an inmate who is a psychiatric patient to another facility, at an increased security risk, to obtain the required wellness services, or increased cost to bring a specialist in-house to the correctional facility. Such security risks and costs can be eliminated or at least reduced when the tools disclosed herein are deployed in such correctional settings.

For example, the inmate may be brought to a monitored room or other supervised environment within the correctional facility and provided with a tablet computer (or other terminal) that the inmate can use under controlled circumstances. In the correctional setting, devices that provide access to the platform or tools disclosed herein are carefully configured to allow the user only to such tools (and not to general access to outside of the correctional facility). Such terminal affords the inmate access to the wellness professional, with some privacy, while the required security over the inmate can be maintained, without a need to transport the inmate to another facility to receive treatment and without a need to compensate to compensate the wellness professional for travel to the correctional facility. Further, the form factor and materials used for the devices can be selected appropriately for the correctional setting. For example, the device may be encased in materials of military-grade standards, such as polycarbonates, silicon, or other materials to ensure safety.

Such tools allow real-time, live, collaborative care between providers and between inmate-patient and provider(s) upon discharge from, for example, an inpatient setting (at an institution with possibly some attendant security risks) to the outpatient correctional setting, while maintaining, or possibly even improving, quality of care, speed of care, efficacy of the system, costs, etc. For example, the tools allow special requirements of the inmate-patient to be specified and then can identify providers who specialize in such specific needs of the inmate-patient (e.g., drug detoxification or dependency), and increases the probability that the inmate-patient will receive more targeted care in a more timely fashion, to benefit inmates in the correctional setting with wellness benefits, as well as well as generally mitigating costs is the wellness care system.

The costs of incarcerating individuals with severe psychiatric disorders are enormous. According to recent estimates, it costs taxpayers $15 billion annually to treat individuals with psychiatric disorders in jails and prisons. In correctional settings, inmates with mental illnesses experience a significantly longer stay than do people without mental illness. Such extended incarceration can be attributed to many factors, including extensions as punishment for behavior that is a result of mental illness.

On the other hand, the tools disclosed herein when employed in a correctional setting for such inmates to obtain the wellness services to address their wellness needs can shorten the period of incarceration for such inmates by providing behavioral health interventions, subverting the complications that arise from mental health conditions.

The tools disclosed herein can also alleviate costs of transporting inmates to obtain outpatient care elsewhere, by facilitating pre-screening of the inmate-patient in advance of a hospital transport. Such system ensures that the inmate-patient is seen by the most appropriate healthcare provider in a more timely fashion and removes unnecessary costs and labor burdens from the correctional setting, by eliminating transports in instances in which they are not necessary.

Further, correctional settings typically have a population with a higher-than-average rate of substance abuse, and an inmate with substance abuse issues can be provided with an opportunity to address such issues in an environment with limited externalities or environmental triggers. The tools disclosed herein can facilitate rehabilitation by providing remote access to the appropriate professionals in a contextually relevant manner.

The tools described herein can allow consumers to improve their well-being through simplified access to highly personalized professional advice and content at costs and times that fit their lifestyles, wellness professionals to optimize and grow their practices through personalized, content-rich profiles and automated analytics tools, and insurance companies, corporations and brick-and-mortar wellness facilities to administer cost-effective wellness programs.

Such tools enable an enterprise to operate on multiple fronts.

On the B2B (business-to-business) side, the enterprise can charge, for example, professional therapists a monthly fee to use the aforementioned web tools. Professional subscribers benefit from increased exposure to a national audience of consumers that they can counsel at any hour via online video, web-based text, or telephone, convenient scheduling tools that help maintain a high level of sessions, streamlined payment processing through the aforementioned system, and analytic and profile optimization tools to maximize online discovery.

On the B2C (business-to-consumer) side, consumers benefit from access to thousands of therapists that preferably have been rated by other users, detailed information regarding background of each practitioner, and moreover the ability to have on-demand counseling sessions in the convenience of their own home over any web browser-equipped smartphone, tablet or computer.

The aforementioned specific embodiments are illustrative, and many variations can be introduced on these embodiments without departing from the spirit of the disclosure. For example, elements and/or features of different examples and illustrative embodiments may be combined with each other and/or substituted for each other within the scope of this disclosure.

The orders in which the steps are performed in the aforementioned methods are not limited to those shown in the examples of FIGS. 6A-6B, 8A-8B and 10, and may be switched as long as similar results are achieved. Also, it should be noted that the methods illustrated in the examples of FIGS. 6A-6B, 8A-8B and 10 may be implemented using any of the systems described in connection with FIGS. 1A-1C.

What is claimed is:

1. A system for a user to obtain services from a health or wellness professional through a network, the system comprising a patient-to-professional matching apparatus that comprises:
a non-transitory medium storing one or more programs of executable instructions; and
a processor configured to execute the one or more programs of executable instructions to perform, in response to a request received from a user of a user terminal for a consultation session, a matching process to match said user to one or more wellness professionals registered in a wellness professional database that registers, for each registered wellness professional amongst plural wellness professionals, a professional profile of the registered wellness professional,
wherein said matching process performed by the processor includes:
(a) determining whether said user is registered in a user database;
(b) collecting, upon determining in (a) that said user is registered in the user database, patient wellness data;
(c) generating one or more wellness indices based on the patient wellness data, collected in (b);
(d) matching the user to one or more available professionals amongst plural wellness professionals registered in the wellness professional database, the matching being based on (i) the profiles of the registered wellness professionals and (ii) said one or more wellness indices generated in (c); and
(e) causing a user interface to be provided on the user terminal including links for the user to initiate a consultation session through the network with a wellness professional amongst the one or more available professionals.

2. The system of claim 1, wherein the user is an inmate in a correctional facility, and the user terminal is configured to limit communications through the network solely to wellness service providers registered in the wellness professional database.

3. The system of claim 1, wherein the user is an inmate-patient in a correctional facility, the patient wellness data collected in (b) indicate that the inmate-patient has drug dependency, and the wellness indices generated in (c) are employed in (d) to match the inmate-patient to wellness service providers specializing, or having experience, in treating drug dependency, according to the professional profile of the matched wellness service providers.

4. The system of claim 1, wherein the user is a wellness professional treating an inmate-patient in a correctional facility, and the patient wellness data of the inmate-patient is supplied in (b) to indicate that the inmate-patient requires drug detoxification or has drug dependency, the inmate-patient is matched in (d) to a wellness specialist specializing in drug detoxification or treating drug dependency, and the user interface provided in (e) permits the wellness professional user and the specialist to collaborate to provide wellness care to the inmate-patient in the correctional facility.

5. The system of claim 1, wherein the user is an inmate-patient in a correctional facility, the patient wellness data collected in (b) indicate that the inmate-patient has, or has a high likelihood of, psychiatric disorder or mental illness, and the wellness indices generated in (c) are employed in (d) to match the inmate-patient to wellness service providers specializing in said psychiatric disorder or mental illness, according to the professional profile of the matched wellness service providers.

6. The system of claim 1, wherein the user is a wellness professional treating an inmate-patient in a correctional facility, and the patient wellness data of the inmate-patient is supplied in (b) to indicate that the inmate-patient has, or has a high likelihood of, psychiatric disorder or mental illness, the inmate-patient is matched in (d) to a wellness specialist specializing in said psychiatric disorder or mental illness, and the user interface provided in (e) permits the wellness professional user and the specialist to collaborate to provide wellness care to the inmate-patient in the correctional facility.

7. The system of claim 1, wherein the user is a wellness professional treating an inmate-patient in a correctional facility, the inmate-patient is matched in (d) to a wellness specialist having a specialty matching the patient wellness data of the inmate-patient, and the user interface provided in (e) permits the wellness professional user and the wellness specialist to collaborate to prescreen the inmate-patient.

8. The system of claim 1, wherein the prescreening of the inmate-patient through collaboration by the wellness professional user and the wellness specialist via the user interface provided in (e) includes determination of whether wellness concerns of the inmate-patient constitutes an emergency requiring transport to a site external to the correctional facility, to obtain treatment.

9. The system of claim 1, wherein the patient wellness data collected in (b) includes symbolic data indicating social information, and at least one numerical index calculated in (c) reflects said social information captured by the symbolic data.

10. The system of claim 1, wherein the user is a student, the patient wellness data collected in (b) includes symbolic data indicating academic information, and at least one numerical index calculated in (c) reflects said academic information captured by the symbolic data.

11. The system of claim 10, wherein the academic information captured by the symbolic data reflects time within academic year.

12. The system of claim 10, wherein the academic information captured by the symbolic data includes one or more areas of study of the user.

13. The system of claim 1, wherein the patient wellness data collected in (b) includes environmental information, and at least one numerical index calculated in (c) reflects said environmental information.

14. The system of claim 1, wherein the patient wellness data collected in (b) includes location information, and at least one numerical index calculated in (c) reflects said location information.

15. The system of claim 1, wherein the patient wellness data collected in (b) include data automatically collected through the network from a source other than the user.

16. The system of claim 1, wherein the patient wellness data collected in (b) include history of the user of serious mental illness, automatically collected through the network from a source other than the user.

17. The system of claim 1, wherein the patient wellness data collected in (b) include history of the user of substance abuse, automatically collected through the network from a source other than the user.

18. The system of claim 1, wherein the patient wellness data collected in (b) include history of the user of personality disorder, automatically collected through the network from a source other than the user.

19. A patient-to-professional connection application that includes one or more programs of instructions embodied in a non-transitory medium and executable by a processor of a computer to cause the computer to perform, in response to a request received from a user of a user terminal for a consultation session, a matching process to match said user to one or more wellness professionals registered in a wellness professional database that registers, for each registered wellness professional amongst plural wellness professionals, a professional profile of the registered wellness professional, wherein said matching process performed by the computer includes:
(a) determining whether said user is registered in a user database;
(b) collecting, upon determining in (a) that said user is registered in the user database, patient wellness data;
(c) generating one or more wellness indices based on the patient wellness data, collected in (b);
(d) matching the user to one or more available professionals amongst the plural wellness professionals registered in the wellness professional database, based on (i) the profiles of the registered wellness professionals and (ii) said one or more wellness indices generated in (c) based on the patient wellness data; and
(e) causing a user interface to be provided on the user terminal including links for the user to initiate a consultation session through a network with a wellness professional amongst the one or more available professionals matched in (d) to the user.

20. The patient-to-professional connection application of claim 19, wherein the wellness indices are generated in (c) based additionally on behavioral patterns data registered in association with the user in a patient database that registers patient profile data,

21. The patient-to-professional connection application of claim 19, wherein the wellness indices are generated in (c) based additionally on personal profile information registered in association with the user in a patient database that registers patient profile data,

22. The patient-to-professional connection application of claim 19, wherein
the patient-to-professional matching apparatus is further configured, through execution by the processor of the one or more programs, to receive and process a video stream from the user terminal, and apply an artificial intelligence process to extract one or more physical, emotional, and verbal traits of the user from the processed video,
the extracted traits are included in the patient wellness data collected in (b), and
the wellness indices are generated in (c) based on at least in part on the patient wellness data.

23. The patient-to-professional connection application of claim 19, wherein
the patient-to-professional matching apparatus is further configured, through execution by the processor of the one or more programs, to receive and process an audio stream from the user terminal, and apply an artificial intelligence process to extract one or more physical, emotional, and verbal traits of the user from the processed audio,
the extracted traits are included in the patient wellness data collected in (b), and
the wellness indices are generated in (c) based on at least in part on the patient wellness data.

24. The patient-to-professional connection application of claim 19, wherein
the patient-to-professional matching apparatus is further configured, through execution by the processor of the one or more programs, to receive and process sensory data from the user terminal, and apply an artificial intelligence process to extract one or more physical, emotional, and verbal traits of the user from the sensory data,
the extracted traits are included in the patient wellness data collected in (b), and
the wellness indices are generated in (c) based on at least in part on the patient wellness data.

25. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of underlying medical conditions based on the wellness indices generated in (c).

26. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of an underlying medical condition.

27. The patient-to-professional connection application of claim 19, wherein the one or more available professionals matched in (d) to the user are determined based additionally on the probability of the underlying medical condition.

28. The patient-to-professional connection application of claim 27, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of underlying psychological conditions based on the wellness indices generated in (c).

29. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of an underlying psychological condition.

30. The patient-to-professional connection application of claim 29, wherein the one or more available professionals matched in (d) to the user are determined based additionally on the probability of the underlying psychological condition.

31. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of underlying psychiatric conditions based on the wellness indices generated in (c).

32. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of an underlying psychiatric condition.

33. The patient-to-professional connection application of claim 32, wherein the one or more available professionals matched in (d) to the user are determined based additionally on the probability of the underlying psychiatric condition.

34. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of disorders based on the wellness indices generated in (c).

35. The patient-to-professional connection application of claim 19, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of one or more particular disorders.

36. The patient-to-professional connection application of claim 35, wherein the one or more available professionals matched in (d) to the user are determined based additionally on the probability of the one or more particular disorders.

37. A method performed by a computer executing one or more programs of instructions embodied in a non-transitory medium, in response to a request received by the computer from a user of a user terminal for a consultation session, to match said user to one or more wellness professionals registered in a wellness professional database that registers, for each registered wellness professional amongst plural wellness professionals, a professional profile of the registered wellness professional, the method comprising:
(a) determining whether said user is registered in a user database;
(b) collecting, upon determining in (a) that said user is registered in the user database, patient wellness data;
(c) generating one or more wellness indices based on the patient wellness data, collected in (b), of the user;
(d) matching the user to one or more available professionals amongst the plural wellness professionals registered in the wellness professional database, based on (i) the profiles of the registered wellness professionals and (ii) said one or more wellness indices generated in (c) based on the patient wellness data; and
(e) causing a user interface to be provided on the user terminal including links for the user to initiate a consultation session through a network with a wellness professional amongst the one or more available professionals matched in (d) to the user.

38. The method of claim 37, wherein the wellness indices are generated in (c) based additionally on behavioral patterns data registered in association with the user in a patient database that registers patient profile data.

39. The method of claim 37, wherein the wellness indices are generated in (c) based additionally on personal profile information registered in association with the user in a patient database that registers patient profile data,

40. The method of claim 37, wherein
the patient-to-professional matching apparatus is further configured, through execution by the processor of the one or more programs, to receive and process a video stream from the user terminal, and apply an artificial intelligence process to extract one or more physical, emotional, and verbal traits of the user from the processed video,
the extracted traits are included in the patient wellness data collected in (b), and
the wellness indices are generated in (c) based on at least in part on the patient wellness data.

41. The method of claim 37, wherein
the patient-to-professional matching apparatus is further configured, through execution by the processor of the one or more programs, to receive and process an audio stream from the user terminal, and apply an artificial intelligence process to extract one or more physical, emotional, and verbal traits of the user from the processed audio,
the extracted traits are included in the patient wellness data collected in (b), and
the wellness indices are generated in (c) based on at least in part on the patient wellness data.

42. The method of claim 37, wherein
the patient-to-professional matching apparatus is further configured, through execution by the processor of the one or more programs, to receive and process sensory data from the user terminal, and apply an artificial intelligence process to extract one or more physical, emotional, and verbal traits of the user from the sensory data,
the extracted traits are included in the patient wellness data collected in (b), and
the wellness indices are generated in (c) based on at least in part on the patient wellness data.

43. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of underlying medical conditions based on the wellness indices generated in (c).

44. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of an underlying medical condition.

45. The method of claim 37, wherein the one or more available professionals matched in (d) to the user are determined based additionally on the probability of the underlying medical condition.

46. The method of claim 45, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of underlying psychological conditions based on the wellness indices generated in (c).

47. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of an underlying psychological condition.

48. The method of claim 47, wherein the one or more available professionals matched in (d) to the user are determined based additionally on the probability of the underlying psychological condition.

49. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of underlying psychiatric conditions based on the wellness indices generated in (c).

50. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of an underlying psychiatric condition.

51. The method of claim 50, wherein the one or more available professionals matched in (d) to the user are determined based additionally on the probability of the underlying psychiatric condition.

52. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine one or more candidates of disorders based on the wellness indices generated in (c).

53. The method of claim 37, wherein the patient-to-professional matching apparatus is further configured, through execution by the processor of the one or more programs, to receive data from the user terminal, apply an artificial intelligence process to extract one or more physical, emotional, and verbal traits of the user from the received data, include the extracted traits in the patient wellness data collected in (b), and determine, based on the wellness indices generated in (c), a probability of one or more particular disorders.

54. The method of claim 53, wherein the one or more available professionals matched in (d) to the user are determined based additionally on the probability of the one or more particular disorders.
